(19) United States
(12) Patent Application Publication
(10) Pub. No.: US 2024/0381236 A1
(43) Pub. Date: Nov. 14, 2024

(54) METHODS AND SYSTEM TO ACCESS SERVICES IN A MULTI-RADIO ACCESS TECHNOLOGY NETWORK ENVIRONMENT

(71) Applicant: SAMSUNG ELECTRONICS CO., LTD., Suwon-si (KR)

(72) Inventors: Sivasankar COMARAVELOU, Bengaluru (IN); Prasad Basavaraj DANDRA, Bengaluru (IN); Lalith KUMAR, Bengaluru (IN)

(73) Assignee: SAMSUNG ELECTRONICS CO., LTD., Suwon-si (KR)

(21) Appl. No.: 18/662,535

(22) Filed: May 13, 2024

(30) Foreign Application Priority Data
May 13, 2023 (IN) 202341033825
May 10, 2024 (IN) 202341033825

(51) Int. Cl. H04W 48/18; H04W 76/10

(52) U.S. Cl. CPC H04W 48/18; H04W 76/10

(57) ABSTRACT

A method for accessing one or more services by a User Equipment (UE) in a multi-Radio Access Technology (multi-RAT) network, includes: receiving, from applications associated with the UE, a request to access at least one of services or slices within the multi-RAT network; based on the received request and mapping information, determining at least one of RATs or Subscription Permanent Identifiers (SUPIs). The mapping information indicates a relationship between slices and at least one of RATs associated with networks within the multi-RAT network and SUPIs stored at the UE; and based on the determined at least one of RATs, and the SUPIs to access the requested at least one of the services or the slices, establishing a connection with at least one of the networks within the multi-RAT network.

### CROSS-REFERENCE TO RELATED APPLICATION

This application is based on and claims priority under 35 U.S.C. § 119 to Indian patent application No. 202341033825, filed on May 13, 2023, in the Korean Intellectual Property Office, the disclosure of which is incorporated by reference herein in its entirety.

### BACKGROUND

### 1. Field

The disclosure generally relates to mobile communication networks, and more particularly, relates to methods and systems to access one or more services or slices in a multi-Radio Access Technology (multi-RAT) network environment.

### 2. Description of Related Art

5G Slicing (5GS) supports both terrestrial 3rd Generation Partnership Project (3GPP) next generation radio access network (NG-RAN) and non-terrestrial NG-RAN access technologies. The non-terrestrial NG-RAN technology assists in extending 5G services to areas lacking coverage or sufficient connectivity, enhancing a performance of terrestrial networks. The non-terrestrial NG-RAN technology ensures consistent service for a user equipment (UE) and mobile platforms such as passenger vehicles, aircraft, ships, high-speed trains, and buses, thereby reinforcing service reliability.

The non-terrestrial NG-RAN technology enhances service availability universally, particularly for critical communications and future railway, maritime, and aeronautical communications. Further, network slices tailored to specific use cases can be deployed in different technologies like standalone non-public network (SNPN), reduced capability (RedCap), terrestrial NG-RAN and non-terrestrial NG-RAN environments by mobile network operators or private vendors. The network slicing is also applicable to beyond 5G or 6G networks and radio access technologies (RATs) (or sub-RATs) deployed under networks. Moreover, a network environment supporting these different combinations of network and RATs mentioned earlier, are generally referred to as a multi-RAT network environment.

However, when a requested slice or a service from a UE is rejected by one of the RAT of a public land mobile network (PLMN)/SNPN, the UE considers the rejection for the entire PLMN/SNPN, thus the UE fails to access the rejected slice and/or the service even when another RAT of the same PLMN/SNPN could provide the requested slice or the service to the UE. Similarly, when a requested slice or a service from a UE is rejected for one subscription permanent identifiers (SUPI), the UE considers the rejection for all the configured SUPIs at the UE. Thus, the UE fails to access the rejected/not-supported slice or the service even when another SUPI of the UE could provide the rejected slice or the service from another RAT to the UE.

The similar challenges are experienced when the requested slices or the services are rejected for cells, i.e., a registration area (RA) or tracking area identity (TAI) of a particular RAT of the PLMN/SNPN. Moreover, the UE or the network does not maintain a list of rejected services/slice information, leading to same challenge when the UE tries to access the requested services or the slices from a different location.

Generally, when a slice is supported in all satellite RAT types, a RAT priority selection is not defined properly. Consequently, the UE may camp on a geosynchronous orbit (GEO)-cell coverage even when a low earth orbit (LEO)-cell or a medium earth orbit (MEO)-cell is available. This will result in delayed latency and delayed services for the UE.

Therefore, there exists a need to find a solution for the above-mentioned technical problems associated with network slice and service management in 5G and Beyond 5G (B5G) networks.

### SUMMARY

According to an aspect of the disclosure, a method for accessing one or more services by a User Equipment (UE) in a multi-Radio Access Technology (multi-RAT) network, includes: receiving, from one or more applications associated with the UE, a request to access at least one of one or more services or one or more slices within the multi-RAT network; based on the received request and mapping information, determining at least one of one or more RATs or one or more Subscription Permanent Identifiers (SUPIs), wherein the mapping information indicates a relationship between a plurality of slices and at least one of a plurality of RATs associated with one or more networks within the multi-RAT network and a plurality of SUPIs stored at the UE; and based on the determined at least one of one or more RATs, and the one or more SUPIs to access the requested at least one of the one or more services or the one or more slices, establishing a connection with at least one of the one or more networks within the multi-RAT network.

According to an aspect of the disclosure, a User Equipment (UE) to access one or more services in a multi-Radio Access Technology (multi-RAT) network, includes: at least one processor configured to: receive, from one or more applications associated with the UE, a request to access at least one of one or more services or one or more slices within the multi-RAT network; based on received request and mapping information, determine at least one of one or more RATs or one or more Subscription Permanent Identifiers (SUPIs), wherein the mapping information indicates a relationship between a plurality of slices, and at least one of a plurality of RATs associated with one or more networks within the multi-RAT network and a plurality of SUPIs stored at the UE; and based on the determined at least one of one or more RATs or one or more SUPIs to access the requested at least one of the one or more services or the one or more slices, establish a connection with at least one of the one or more networks within the multi-RAT network.

According to an aspect of the disclosure, a method for enabling access to one or more services to a User Equipment (UE) by a network device in a multi-Radio Access Technology (RAT) network, includes: receiving, from the UE, a request to access at least one of one or more services or one or more slices within the multi-RAT network; and transmitting, to the UE, a response message indicating one of a rejection or an acceptance of the at least one of the one or more services or the one or more slices within the received request and mapping information, wherein the mapping information includes at least one of a User Equipment Routing Selection Policy (URSP), an Access Network Discovery and Selection Policy (ANDSP) or a Home network configured or controlled policy for selecting RAT based on services or slices, a configured Network Slice Selection Assistance Information (NSSAI), an allowed NSSAI, an alternative NSSAI, a slice or service priority, a supported-band related information, a SUPI, and a location associated with each of the one or more RATs within the multi-RAT network for Public Land Mobile Networks PLMNs/Standalone Non-Public Networks (SNPNs).

According to an aspect of the disclosure, a network device for enabling access to one or more services to a User Equipment (UE) in a multi-Radio Access Technology (RAT) network, includes: at least one processor configured to: receive, from the UE, a request to access at least one of one or more services or one or more slices from the network within the multi-RAT network; and transmit a response message indicating one of a rejection or an acceptance of the at least one of the one or more services or the one or more slices with the received request and mapping information, the mapping information includes at least one of a User Equipment Routing Selection Policy (URSP), an Access Network Discovery and Selection Policy (ANDSP), a Home Network configured or controlled policy for selecting RAT based on services or slices, a configured Network Slice Selection Assistance Information (NSSAI), an allowed NSSAI, an alternative NSSAI, a slice or service priority, a supported-band related information, a SUPI, and a location associated with each of the one or more RATs within the multi-RAT network for Public Land Mobile Networks PLMNs/Standalone Non-Public Networks (SNPNs).

### BRIEF DESCRIPTION OF THE DRAWINGS

To further clarify the advantages and features of the disclosure, a more particular description of the disclosure will be rendered by reference to specific embodiments thereof, which are illustrated in the appended drawings. These drawings depict only typical embodiments of the disclosure and are therefore not to be considered limiting of its scope. The disclosure will be described and explained with additional specificity and detail in the accompanying drawings.

These and other features, aspects, and advantages of the disclosure will become better understood when the following detailed description is read with reference to the accompanying drawings in which like characters represent like parts throughout the drawings, wherein:

FIGS. 1A and 1B illustrate one or more problems associated with accessing one or more services and/or slices within a multi-RAT network environment, respectively, according to the related art;

FIGS. 2A and 2B illustrate one or more solutions to the one or more problems illustrated in FIGS. 1A and 1B, according to one or more embodiments of the disclosure;

FIG. 3 illustrates a first problem scenario associated with the multi-RAT network environment, according to the related art;

FIG. 4 illustrates a second problem scenario associated with the multi SIM and multi-RAT network environment, according to the related art;

FIGS. 5A and 5B illustrate a third problem scenario associated with the multi-RAT network environment, according to the related art;

FIG. 6 illustrates a fourth problem scenario associated with the multi-RAT network environment, according to the related art;

FIG. 7 illustrates a first solution scenario corresponding to the first problem scenario of FIG. 3, according to one or more embodiments of the disclosure;

FIGS. 8A and 8B illustrate a second solution scenario corresponding to the first problem scenario of FIG. 3, according to one or more embodiments of the disclosure;

FIG. 9 illustrates a third solution scenario corresponding to the first problem scenario of FIG. 3, according to one or more embodiments of the disclosure;

FIGS. 10A and 10B illustrate a fourth solution scenario corresponding to the first problem scenario of FIG. 3, according to one or more embodiments of the disclosure;

FIGS. 11A and 11B illustrate a first solution scenario corresponding to the second problem scenario of FIG. 4, according to one or more embodiments of the disclosure;

FIGS. 12A and 12B illustrate a second solution scenario corresponding to the second problem scenario of FIG. 4, according to one or more embodiments of the disclosure;

FIGS. 13A and 13B illustrate a third solution scenario corresponding to the second problem scenario of FIG. 4, according to one or more embodiments of the disclosure;

FIGS. 14A and 14B illustrate a solution scenario corresponding to the third problem scenario of FIGS. 5A-5B, according to one or more embodiments of the disclosure;

FIG. 15 illustrates a solution scenario corresponding to the fourth problem scenario of FIG. 6, according to one or more embodiments of the disclosure;

FIG. 16 illustrates a method for accessing one or more services by UE in the multi-RAT network environment, according to one or more embodiments of the disclosure;

FIG. 17 illustrates a method for enabling access to one or more services to the UE by a network device in the multi-RAT network environment, according to one or more embodiments of the disclosure;

FIG. 18 illustrates a configuration of the UE in a wireless communication system, according to an embodiment of the disclosure; and

FIG. 19 illustrates an exemplary diagram of a network device, according to an embodiment of the disclosure.

Further, skilled artisans will appreciate that elements in the drawings are illustrated for simplicity and may not have necessarily been drawn to scale. For example, the flow charts illustrate the method in terms of the most prominent operations involved to help to improve understanding of aspects of the disclosure. Furthermore, in terms of the construction of the device, one or more components of the device may have been represented in the drawings by conventional symbols, and the drawings may show only those specific details that are pertinent to understanding the embodiments of the disclosure so as not to obscure the drawings with details that will be readily apparent to those of ordinary skill in the art having the benefit of the description herein.

### DETAILED DESCRIPTION

For the purpose of promoting an understanding of the principles of the disclosure, reference will now be made to the various embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates. It will be understood by those skilled in the art that the foregoing general description and the following detailed description are explanatory of the disclosure and are not intended to be restrictive thereof.

Reference throughout this specification to “an aspect,” “another aspect” or similar language means that a particular feature, structure, or characteristic described in connection with the embodiment is included in at least one embodiment of the disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components. The terms “user” and “participant” may be used interchangeably throughout the specification.

The term “couple” and the derivatives thereof refer to any direct or indirect communication between two or more elements, whether or not those elements are in physical contact with each other. The terms “transmit”, “receive”, and “communicate” as well as the derivatives thereof encompass both direct and indirect communication. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items.

Moreover, multiple functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as Read Only Memory (ROM), Random Access Memory (RAM), a hard disk drive, a Compact Disc (CD), a Digital Video Disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

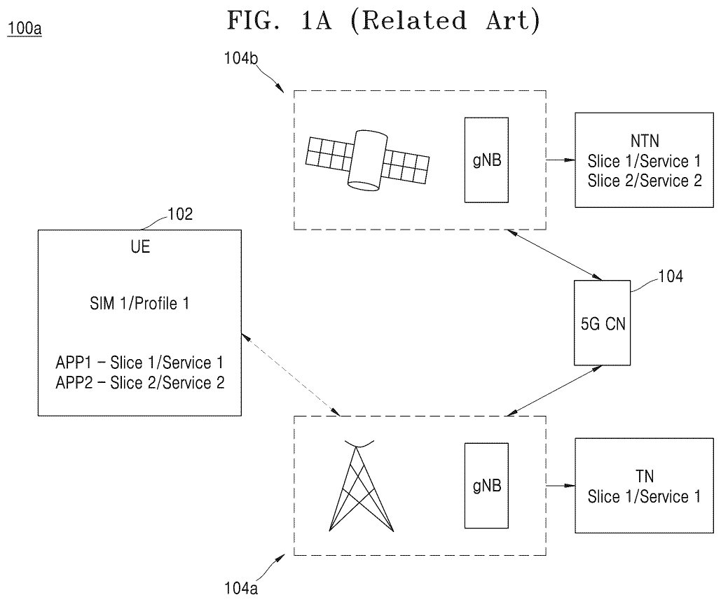

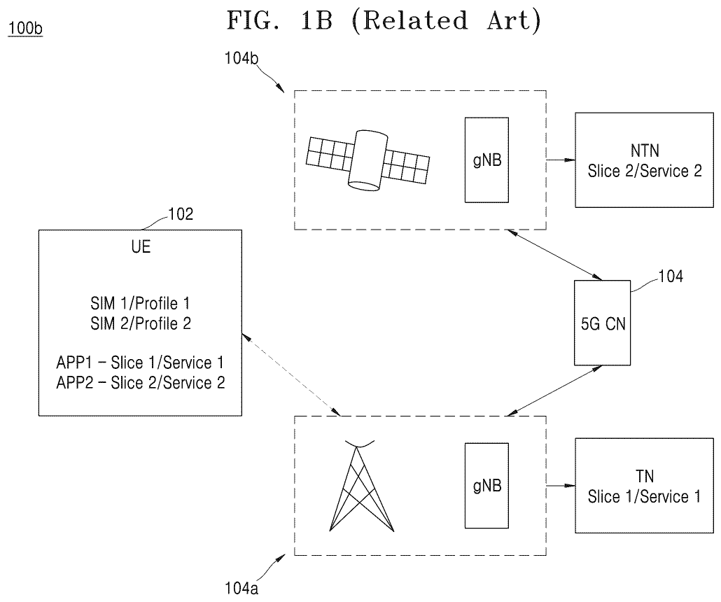

FIGS. 1A and 1B illustrate one or more problems associated with accessing one or more services and/or slices within multi-RAT network environments 100a and 100b (collectively may be referred to as the multi-RAT network environment 100), respectively, according to the related art. The multi-RAT network environments 100a and 100b may include a 5G Core Network (5GCN) 104 (hereinafter referred to as the network 104) including both a Terrestrial Network (TN) 104a and Non-Terrestrial Network (NTN) 104b. In one embodiment, the NTN 104b may refer to networks operating through an air/space borne vehicle for communication. In particular, the NTN 104b may include a network such as, but is not limited to, a satellite-based cellular network, a high altitude platform station-based cellular network, an underwater network, or an air-to-ground-based network. In some embodiments, the NTN may also include an Unmanned Aerial Vehicle (UAV)-based cellular network. The TN 104a may correspond to a communication network that operates primarily on the Earth's surface or within its atmosphere. The TN 104a may be based on various technologies such as, but not limited to, wired infrastructure (e.g., fiber optic cables), wireless communication towers (e.g., cell towers), and other terrestrial-based systems. Examples of the TN 104a may include, but are not limited to, cellular networks, internet backbone networks, landline telephone networks, Wi-Fi networks, etc. The multi-RAT network environment 100 may correspond to a network that supports multiple RATs to enable effective and seamless communication. The multi-RAT network environment 100 may include, but not limited to, Terrestrial or Non-Terrestrial Network, 5G Reduced Capability (REDCAP) network, Beyond 5G or 6G of a Public Land Mobile Network (PLMN) or a Standalone Non-Public Mobile Network (SNPN).

The multi-RAT network environment 100a and 100b may include an UE 102. In the multi-RAT network environment 100a, the UE 102 may be a single Subscriber Identity Module (SIM) device, whereas in the multi-RAT network environment 100b, the UE 102 may correspond to a multi-SIM (MUSIM) device. In an exemplary embodiment, the UE 102 may be a dual SIM device.

In FIG. 1A, the UE 102 is a single SIM device configured with a single network profile. The UE 102 may include a plurality of applications running on the UE 102 to perform one or more operations. Each of the plurality of applications may be configured to provide one or more network services to the UE 102 via the one or more slices of the network 104. The one or more slices may be provided by the one or more networks 104a, 104b of the multi-RAT network environment 100. Examples of the plurality of applications may include, but are not limited to, a calling application, a gaming application, a video conferencing application, and so forth. Moreover, examples of the UE 102 may include, but are not limited to, computers, tablets, mobile devices, or any other device capable of sending and receiving information to and from a network.

In an example embodiment, the UE 102 may include two applications, i.e., APP1 and APP2 that require access to at least one of a slice 1 or a service 1 and a slice 2 or a service 2, respectively, from the network 104. Further, the TN 104a may only support the service 1 or the slice 1. The NTN may support both the slice 1 or the service 1 and the slice 2 or the service 2. However, the UE 102 may try to access both the slices (i.e., the slice 1 and slice 2) and/or the services (i.e., the service 1 and the service 2) from the TN 104a. Thus, the UE 102 transmits a registration request to the required slices 1 and 2 or the services 1 and 2 from the TN 104a. In response, the TN 104a may transmit a registration accept message indicating that the slice 1 or the service 1 is allowed, and the slice or the service 2 is rejected. Thus, the APP 1 at the UE 102 may get the services, however the APP 2 at the UE 102 may not get any service. In particular, even when the different RAT (i.e., the NTN 104b) was able to provide both the requested slices and/or the services to the UE 102, the UE 102 may consider the rejection for the entire PLMN/SNPN and/or the multi-RAT network environment 100. Thus, the UE 102 may not get access to the rejected slice/service via the another RAT from the same PLMN/SNPN/RedCap/B5G/6G.

In FIG. 1B, the UE 102 is a multi-SIM device including a SIM1 configured with a network profile 1 and a SIM 2 configured with a network profile 2. Further, the TN 104a may be configured to support slice 1 and/or the service 1 and the NTN 104b may be configured to support slice 2 and/or the service 2. However, when the UE 102 tries to access services/slices for the APP 1 and the APP2, as discussed above, the UE 102 may request TN 104a only. Thus, in response, the TN 104a may transmit the registration accept message indicating that the slice 1 or the service 1 is allowed, and the slice or the service 2 is rejected. Accordingly, the APP 1 at the UE 102 may get the services, however the APP 2 at the UE 102 may not get any service. Therefore, even when the SIM2 of the UE 102 may be able to connect to the NTN 104b to access the rejected slice or service, the UE 102 may consider the rejection of the requested slice or service for the entire PLMN/SNPN, as UE 102 may include any information on which slice/service is support by which RAT-based network of the multi-RAT network environment 100.

In some embodiments, the request from the UE 102 is rejected at a particular cell, the UE 102 may consider said rejection for all the cells of the same PLMN/SNPN. Further, the UE 102 may not maintain any list of rejected slices/services and the corresponding RAT, therefore when the UE 102 moves to another location or switches to different RATs, the rejected slice/service list may be deleted, and the UE 102 may try to access the required slices/services via a wrong combination of RAT or SIM.

Moreover, in a case that a slice or service is supported in all RATs, a RAT priority may not be defined either at the UE 102 or the network 104, hence the UE 102 may camp/register on a low coverage cell, even when a high coverage cell is available. This results in no service or delayed latency services for the UE 102.

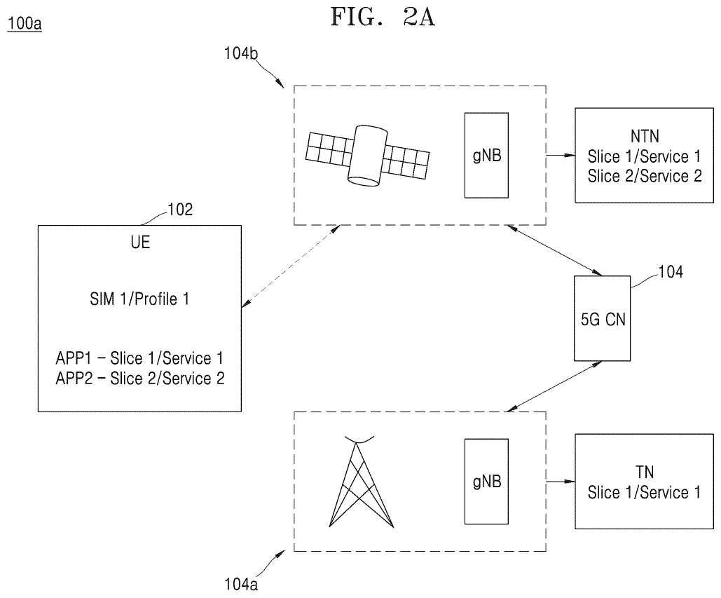

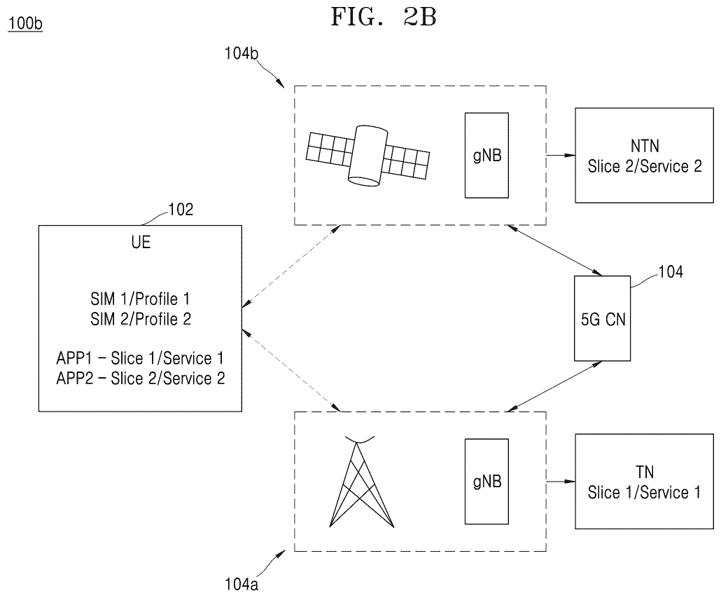

FIGS. 2A and 2B illustrate one or more solutions to the one or more problems illustrated in FIGS. 1A and 1B. FIG. 2A illustrates the multi-RAT network environment 100a where the UE 102 corresponds to a single SIM device. In the solution disclosed, the UE 102 may be preconfigured with a mapping information indicates a relationship between a plurality of slices/services, and at least one a plurality of RATs associated with one or more networks within the multi-RAT network environment 100a, or a plurality of Subscriber Universal Personal Identifiers (SUPIs) stored at the UE 102.

Each of the plurality of SUPI may be associated with a corresponding SIM implemented at the UE 102. In particular, the mapping information may indicate to access a service/slice of the network 104, which particular RAT and/or SUPI needs to be selected. For instance, the mapping information may include that the TN 104a of the network 104 may only support the slice 1 or the service 1, whereas the NTN 104b of the network 104 may support both the slices (i.e., the slice 1 and the slice 2) and/or the services (i.e., the service 1 and the service 2).

Based on this information, to access the slice 1/service 1 or the slice 2/service 2, instead of transmitting the registration request to the TN 104a, the UE 102 may directly connect to the NTN 104b of the same network 104 (i.e., the same PLMN or SNPN). The UE 102 may then transmits the registration request to access the required slices/services and as the NTN 104b is able to support both the slices/services, the UE 102 may get access to each of the requested slices/services. Thus, both the APP1 and the APP2 at the UE 102 may get access to the required services/slices. This saves time and improves the overall user experience of the multi-RAT network environment 100a. In one embodiment, the mapping information as discussed above may be preconfigured at the UE 102 in the USIM or a corresponding memory element. In such embodiments, the mapping information may be preconfigured at the UE 102 by a HPLMN or a network operator.

In an alternative embodiment, the network 104 may include the mapping information. For example, the TN 104a and the NTN 104b may include the required mapping information of the supported slices/services and non-supported slices/services. The TN 104a and the NTN 104b may also include the mapping information corresponding to each other. For instance, the TN 104a may include mapping information corresponding to the NTN 104b indicating the slices/services supported by the NTN 104b, and vice-versa. Thus, in the problem as illustrated in FIG. 1A, when the UE 102 transmits a request to access the slice 1/service 1 and slice 2/service 2 from the TN 104a, the TN 104a may allow the slice 1/service 2 and reject the slice 2/service 2. However, the TN 104a may also transmit the mapping information to the UE 102, such that the UE 102 may be able to access the rejected slices/services from the another RAT-based network, i.e., the NTN 104b. Thus, the UE 102 may get access to both the services as required by the APP 1 and the APP 2.

FIG. 2B illustrates the multi-RAT network environment 100b where the UE 102 corresponds to a multi-SIM device. Similar to the solution disclosed above, the UE 102 may also include the mapping information indicating the relationship between the plurality of slices/services, and the at least one the plurality of RATs associated with one or more networks within the multi-RAT network environment 100b, or a plurality of SUPIs stored at the UE 102. For example, the plurality of SUPIs may correspond to the SIM1 and SIM2 of the UE 102. In the example embodiment, the mapping information may indicate that the slice 1/service 1 is supported by TN 104a and the slice 2/service 2 is supported by the NTN 104b. Thus, based on this information, to access the slice 1/service 1 and the slice 2/service 2, instead of transmitting the registration request only to the TN 104a, the UE 102 may use both the SIMS, i.e., SIM1 and SIM2 to establish connection with both the TN 104a and the NTN 104b to get access to both the services/slices simultaneously. This enables proper utilization of resources at the UE 102 and/or the network 104 and improves overall user experience.

In an alternative embodiment, the network 104 may include the mapping information. For example, the TN 104a and the NTN 104b may include the required mapping information of the supported slices/services and non-supported slices/services. The TN 104a and the NTN 104b may also include the mapping information corresponding to each other. For instance, the TN 104a may include mapping information corresponding to the NTN 104b indicating the slices/services supported by the NTN 104b, and vice-versa. Thus, in the problem as illustrated in FIG. 1B, when the UE 102 transmits a request to access the slice 1/service 1 and slice 2/service 2 from the TN 104a, the TN 104a may allow the slice 1/service 2 and reject the slice 2/service 2. However, the TN 104a may also transmit the mapping information to the UE 102, such that the UE 102 may be able to access the rejected slices/services from the another RAT-based network, i.e., the NTN 104b via another SIM 2. Thus, the UE 102 may get access to both the services as required by the APP 1 and the APP 2.

In one embodiment, the TN 104a and/or the NTN 104b may share the mapping information to the UE 102 via any suitable communication protocol/information element (IE) such as, but not limited to, UE policy container (i.e., UE Routing Selection Policy (URSP)), a Steering Of Roaming/Steering of RAT (SoR) container, a Downlink Network Non-access stratum (DL-NAS) message, etc.

In some embodiment, the network 104 may also share an alternate slice ID for a rejected service/slice in the current RAT. For instance, when the TN 104a is unable to support slice 2, however, the corresponding service 2 may also be supported by a slice 3 which can be supported by the TN 104a, the network 104 may indicate the slice 3 to the UE 102. This enables the UE 102 to access the required service via switching on the RATs.

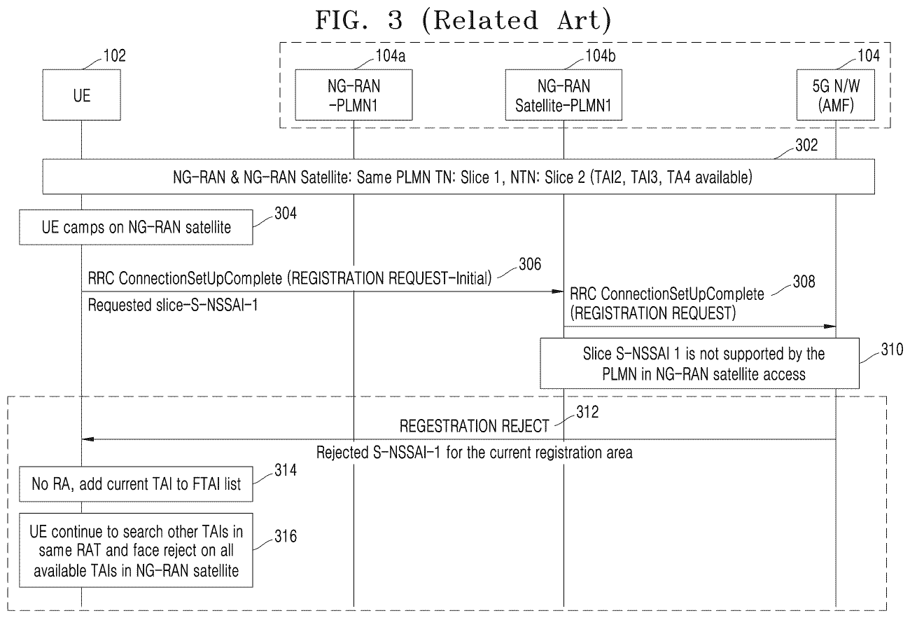

FIG. 3 illustrates a first problem scenario associated with the multi-RAT network environment 100, according to the related art. The first problem scenario involves one or more following preconditions. First, Slice-1 is exclusively provisioned and served by TN 104a, i.e., is only supported within the Tracking Area Identifier (TAI) of the TN 104a. The slice-1 cannot be supported in the TAIs of the Non-Terrestrial Networks (NTN) 104b. Second, The UE 102 lacks a necessary Registration Area (RA) information.

In the first problem scenario, at operation 302, an NG-RAN (that corresponds to the TN 104a) and an NG-RAN satellite (that corresponds to the NTN 104b) are associated with a same Public Land Mobile Network (PLMN) (i.e., PLMN 1) provided by the 5G network 104. The TN 104a supports one or more services associated with the slice-1, while the NTN 104b supports one or more services associated with slice-2, with a coverage including TAI2, TAI3, and TAI4.

At operations 304-306, the UE 102 attempts to camp on the NG-RAN satellite (i.e., the NTN 104b) of the PLMN-1 by transmitting a Radio Resource Control (RRC) connection setup complete message (registration request-initial) to access a Single Network Slice Selection Assistance Information (S-NSSAI)-1.

At operation 308, the NG-RAN satellite (i.e., the NTN 104b) forwards the received RRC connection setup complete message to the 5G network (NW) 104 and/or an associated network entity (e.g., Access and Mobility Management Function (AMF)).

At operation 310, upon reception of the RRC connection setup complete message, the 5G network 104 detects that the S-NSSAI-1 is not supported by the NG-RAN satellite (i.e., the NTN 104b).

At operation 312, upon detection, the 5G-network 104 sends a registration reject message to the UE 102. The registration reject message may include an indication “#62: rejected S-NSSAI-1 for the current RA” to the UE 102.

At operations 314 and 316, the UE 102 may not have the RA list and add a current TAI in a forbidden TAI (FTAI) list. As a result, the UE 102 may only block the current TAI and can only camp for limited or emergency services.

At operation 316, the UE 102 may then search for other TAIs in same RAT-based network (i.e., the NTN 104b), for example, find TAI3, and receive another rejection with the same cause. TAI3 will then be added to the UE's FTAI list. The UE 102 may face a similar rejection when attempting to register on TAI4, and this TAI will also be added to the FTAI list. These operations may continue until the UE 102 tries all the available bands in the NTN 104b, as the UE 102 is unable to successfully register on any of the NTN TAIs due to the missing RA information. In other words, the lack of the RA list during the initial registration rejection leads the UE 102 to sequentially add TAIs to its FTAI list, as it attempts to register on different TAIs within the NTN 104b, without being able to successfully complete the registration process. This may lead to a wastage of resources both at the UE 102 and the NTN 104b side. Moreover, this add to a delay in requested services by the UE 102.

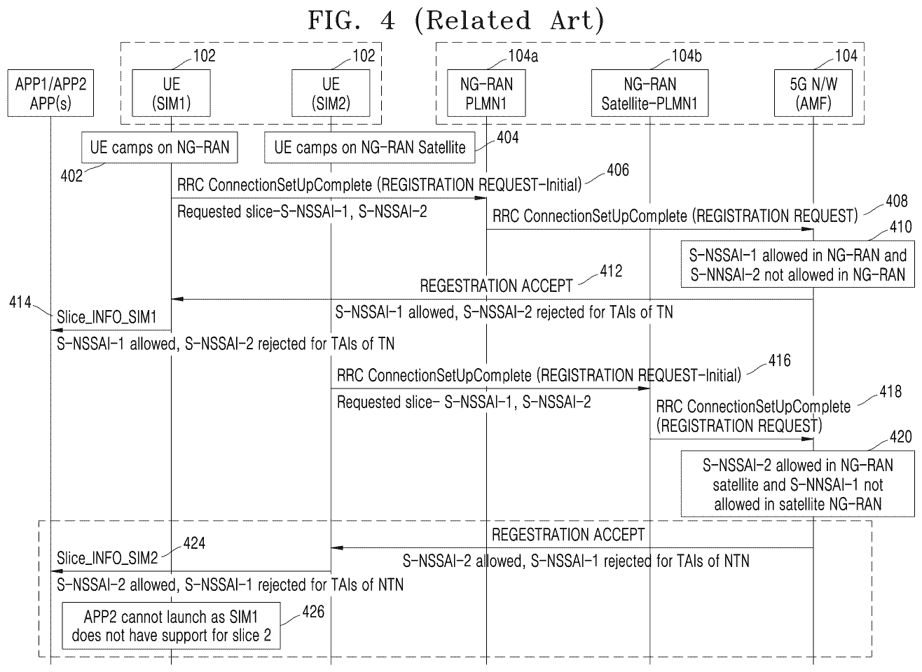

FIG. 4 illustrates a second problem scenario associated with the multi-RAT network environment 100, according to the related art. The sequence flow diagram may include several operations outlined as follows. The second problem scenario involves one or more following preconditions.

First, the UE 102 has two Subscriber Identification Modules (SIMs) or Subscription Permanent Identifiers (SUPIs) associated with separate or same subscriptions.

Second, the UE 102 is configured with two distinct network slices (e.g., slice-1 and slice-2).

Third, the slice-1 is exclusively served by the TN 104a, while the slice-2 is exclusively served by the NTN 104b.

Fourth, Application-1 (App-1) is mapped and associated with the slice-1, while Application-2 (App-2) is mapped and associated with the slice-2.

In the second problem scenario, at operation 402-404, the UE 102 camps on the NG-RAN (i.e., the TN 104a) by utilizing a functionality of a SIM-1 and the UE 102 camps on the NG-RAN-satellite (i.e., the NTN 104b) by utilizing a functionality of a SIM-2.

At operation 406, the UE 102 transmits an RRC connection setup complete message (registration request-initial) to access an S-NSSAI-1 and an S-NSSAI-2 via the SIM 1 and the NG-RAN (i.e., TN 104a).

At operation 408, the NG-RAN (i.e., the TN 104a) forwards the received RRC connection setup complete message to the 5G network 104 and/or the associated AMF.

At operations 410, upon reception of the RRC connection setup complete message, the 5G-network 104 detects that the S-NSSAI-1 is supported by the NG-RAN (the TN 104a) and the S-NSSAI-2 is not supported by the NG-RAN (the TN 104a).

At operation 412, upon detection, the 5G network 104 sends a registration accept message to the UE 102 (SIM-1), where the registration accept message indicates that the S-NSSAI-1 is allowed, and the S-NSSAI-2 is rejected for TAIs of the TN 104a.

At operation 414, the UE 102 (SIM-1) sends a slice info SIM-1 message to the applications, where the slice info SIM-1 message indicates that the S-NSSAI-1 is allowed, and the S-NSSAI-2 is rejected for TAIs of the TN 104a.

At operation 416, the UE 102 transmits an RRC connection setup complete message (registration request-initial) to the NG-RAN satellite (i.e., the NTN 104b) to access the S-NSSAI-1 and the S-NSSAI-2 via the SIM2.

At operations 418, the NG-RAN satellite (the NTN 104b) forwards the received RRC connection setup complete message to the 5G network 104 and/or the AMF.

At operations 420, upon reception of the RRC connection setup complete message from the NG-RAN satellite (the NTN 104b), the 5G network 104 detects that the S-NSSAI-2 is supported by the NG-RAN satellite (the NTN 104b) and the S-NSSAI-1 is not supported by the NG-RAN satellite (the NTN 104b).

At operation 422, upon detection, the 5G network 104 sends a registration accept message to the UE (SIM-2), where the registration accept message indicates that the S-NSSAI-1 is allowed, and the S-NSSAI-2 is rejected for TAIs of the NTN 104b.

At operation 424, the UE 102 (SIM-2) sends a slice info SIM-2 message to the applications, where the slice info SIM-2 message indicates that the S-NSSAI-2 is allowed, and the S-NSSAI-1 is rejected for TAIs of the NTN 104b.

At operation 426, the UE 102 with the SIM-1 registers for both slice-1 and slice-2. The UE 102 is accepted for slice-1 but rejected for slice-2. Thus, the Application-1 (App1) is able to get the related service, while the Application-2 (App2) is unable to launch the requested services. Thus, even when the UE 102 has SIM2/SUPI2 camped on the NTN 104b, the UE 102 does not have the information guiding the UE 102 that the UE 102 can establish a packet data unit (PDU) session using the SIM2/SUPI2 on the NTN 104b to available the service 2 and/or initialize the App-2, the UE 102 fails to get required services. This leads a bad user experience and delayed services to the UE 102.

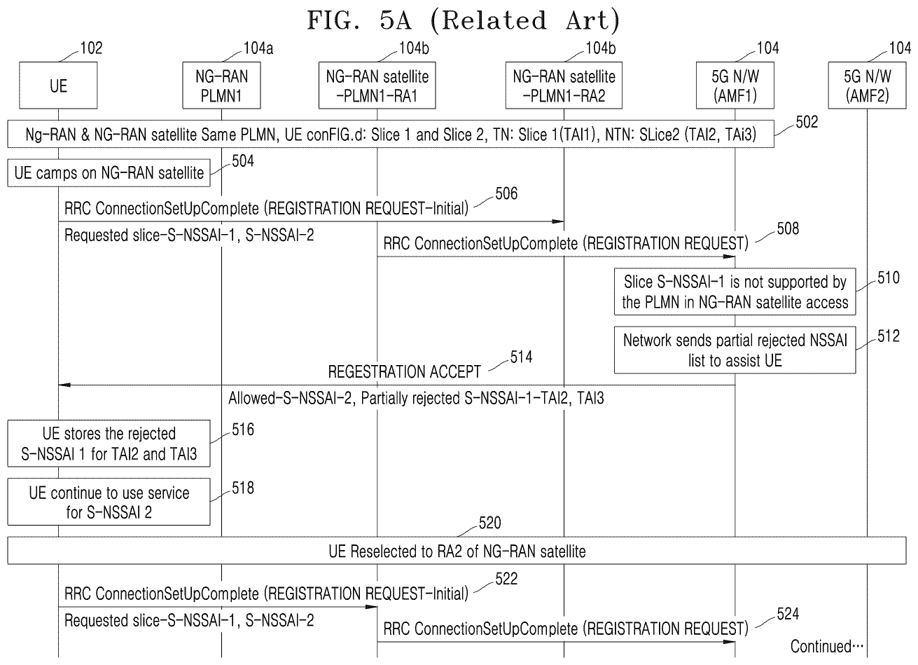

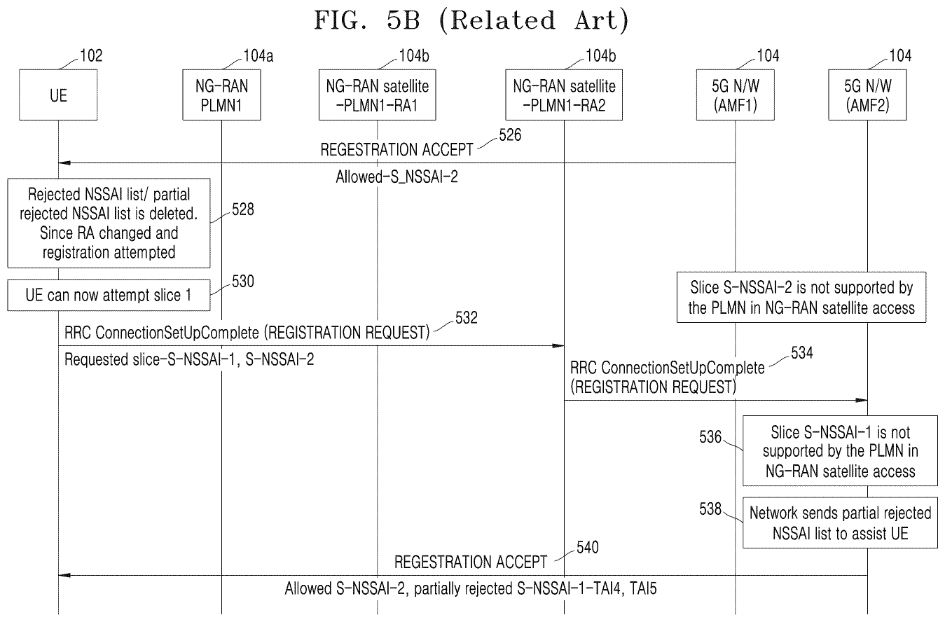

FIGS. 5A and 5B illustrate a third problem scenario associated with the multi-RAT network environment 100, according to the related art. The sequence flow diagram may include several operations outlined as follows. The third problem scenario involves one or more following preconditions. First, Slice-1 and Slice-2 are configured for the UE 102. Second, Slice-1 is under the coverage of the NG-RAN (the TN 104a) TAIs. Slice-2 is under the coverage of the NG-RAN satellite (the NTN 104b TAIs). The TN TAIs are TAI1. The NTN TAIs are TAI2 and TAI3.

In the third problem scenario, at operation 502, the NG-RAN (the TN 104a) and the NG-RAN satellite (the NTN 104b) are associated with the same PLMN. The TN 104a supports one or more services associated with the slice-1 (TAI1), while the NTN 104b supports one or more services associated with Slice-2, with the coverage including TAI2, and TAI4.

At operations 504-506, the UE 102 attempts to camp on the NG-RAN satellite (the NTN 104b) by transmitting a RRC connection setup complete message (registration request-initial) to access the S-NSSAI-1 and the S-NSSAI-2.

At operation 508, the NG-RAN satellite (the NTN 104b) forwards the received RRC connection setup complete message to the 5G network 104 (e.g., AMF-1). At operation 510, upon reception of the RRC connection setup complete message, the 5G-network 104 detects that the S-NSSAI-1 is not supported by the NG-RAN satellite (the NTN 104b). At operation 512-514, the 5G network 104 sends a partial rejected NSSAI list to assist the UE 102 or sends a registration accept message to the UE 102, where the registration to accept message indicates “allowed S-NSSAI-2, partially rejected S-NSSAI-1: TAI2, TAI3”.

At operations 516-518, upon receiving the registration accept message, the UE 102 stores the rejected S-NSSAI-1 for the TAI2, and TAI3, and continues to use service from the S-NSSAI-2.

At operation 520, the UE 102 reselects to RA2 of the NG-RAN satellite (the NTN 104b).

At operation 522, the UE 102 transmits an RRC connection setup complete message (registration request-mobility) to access the S-NSSAI-2.

At operation 524, the NG-RAN satellite (the NTN 104b) forwards the received RRC connection setup complete message to the 5G network 104 (e.g., AMF-1).

At operation 526, upon receiving the RRC connection setup complete message, the 5G network 104 sends a registration accept message, where the registration accept message indicates “allowed S-NSSAI-2”.

At operation 528, the UE 102 then deletes the rejected NSSAI list/partially rejected NSSAI list. Since, the RA (e.g., RA2) is changed and registration attempted.

At operation 530, the UE 102 can attempt the slice-1 again.

At operation 532, the UE 102 transmits a RRC connection setup complete message (registration request-initial) to the NG-RAN satellite (the NTN 104b) (PLMN-1, RA2) to access the S-NSSAI-1 and the S-NSSAI-2.

At operation 534, the NG-RAN satellite (the NTN 104b) (PLMN-1, RA2) forwards the received RRC connection setup complete message to the 5G network 104 (e.g., AMF-2).

At operation 536, upon reception of the RRC connection setup complete message, the 5G-network 104 detects that the S-NSSAI-1 is not supported by the NG-RAN satellite (the NTN 104b).

At operation 538-540, the 5G-network 104 sends a partial rejected NSSAI list to assist the UE 102 or sends a registration accept message to the UE 102, where the registration accept message indicates “allowed S-NSSAI-2, partially rejected S-NSSAI-1: TAI4, TAI5”. So, when the UE 102 moves to a new registration area (RA2) that is covered only by the NTN TAIs, the UE 102 requests mobility registration for the slice 2. This request is accepted, and the previously rejected S-NSSAI list is deleted. The UE 102 then triggers another mobility registration, this time adding the slice 1. However, the slice-1 is rejected again, as the TAIs of the NG-RAN satellite network cannot serve it. Thus, the rejected S-NSSAI list is deleted on every new RA change. Since the partially allowed and rejected S-NSSAI list is mapped to the RA, the partially allowed and rejected S-NSSAI list will either get deleted on every RA change, or there is no specific handling mentioned for the management of the partially allowed and rejected S-NSSAI list. This behavior can lead to potential issues, as the UE 102 may lose the information about the previously rejected S-NSSAI, which could be essential for subsequent registration attempts or service access.

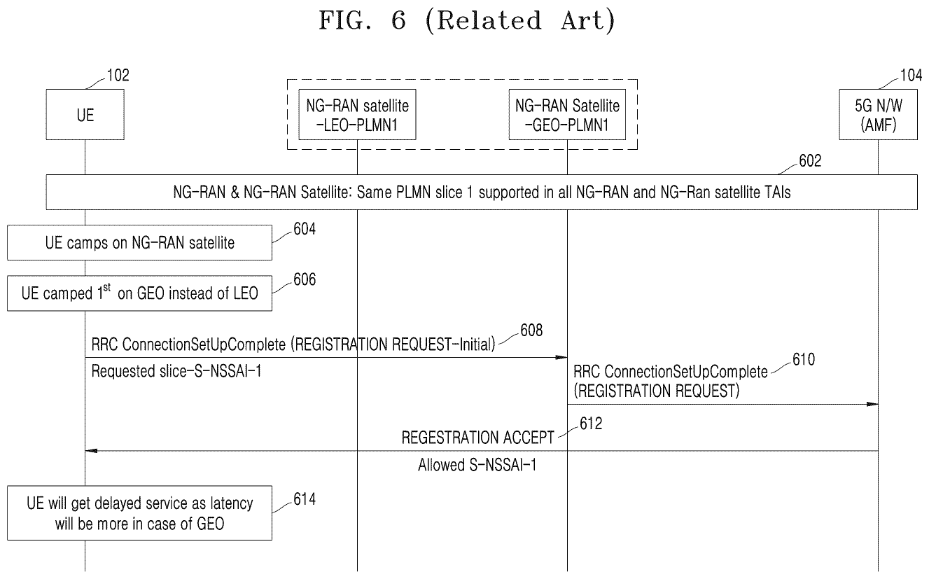

FIG. 6 illustrates a fourth problem scenario associated with the multi-RAT network environment 100, according to the related art. The sequence flow diagram may include several operations outlined as follows. The fourth problem scenario involves one or more following preconditions. First, Slice-1 is configured in the UE for the PLMN-1. Second, Slice-1 is supported in the TAIs of both the TN and the NTN, which includes Low-Earth Orbit (LEO), Geostationary-Orbit (GEO), and Medium-Earth Orbit (MEO) satellite networks.

In the fourth problem scenario, at operation 602, the NG-RAN and NG-RAN satellite are associated with the same PLMN. The slice-1 is supported in all NG-RAN and NG-RAN satellite (TAIs).

At operations 604-608, the UE 102 attempts to camp on the NG-RAN satellite of the PLMN-1 (i.e., GEO) by transmitting an RRC connection setup complete message (registration request-initial) to access the S-NSSAI-1.

At operation 610, the NG-RAN satellite (GEO) forwards the received RRC connection setup complete message to the 5G network 104 (e.g., AMF).

At operation 612, upon reception of the RRC connection setup complete message, the 5G-network 104 sends a registration accept message to the UE 102.

At operation 614, the UE 102 may experience delayed service due to increased latency when camped on the GEO NG-RAN satellite, as compared to the LEO NG-RAN satellite. The UE 102 is under the coverage of the NG-RAN satellite, which includes both LEO and GEO satellite networks. The UE 102 selects and camps on the GEO NG-RAN satellite for the PLMN-1 when it detects the availability of the GEO NG-RAN satellite. The UE 102 then requests and is accepted for the slice 1. The issue is that there is no defined RAT selection logic for the NG-RAN satellite specified in 3GPP specifications 23.122 and 31.102. These specifications do not provide a priority order for the different NG-RAN satellite technologies (LEO, GEO, MEO and other satellite RATs). As a result, the UE 102 camps on the first available GEO cell and registers for the slice-1 with the network 104. This can lead to delayed service or reduced Quality of Service (QOS) compared to the LEO NG-RAN satellite, as the UE 102 is camped on the GEO NG-RAN satellite, which typically has higher latency. The lack of defined RAT selection logic for the NG-RAN satellite technologies in the 3GPP specifications can lead to suboptimal network selection and service experience for the UE 102.

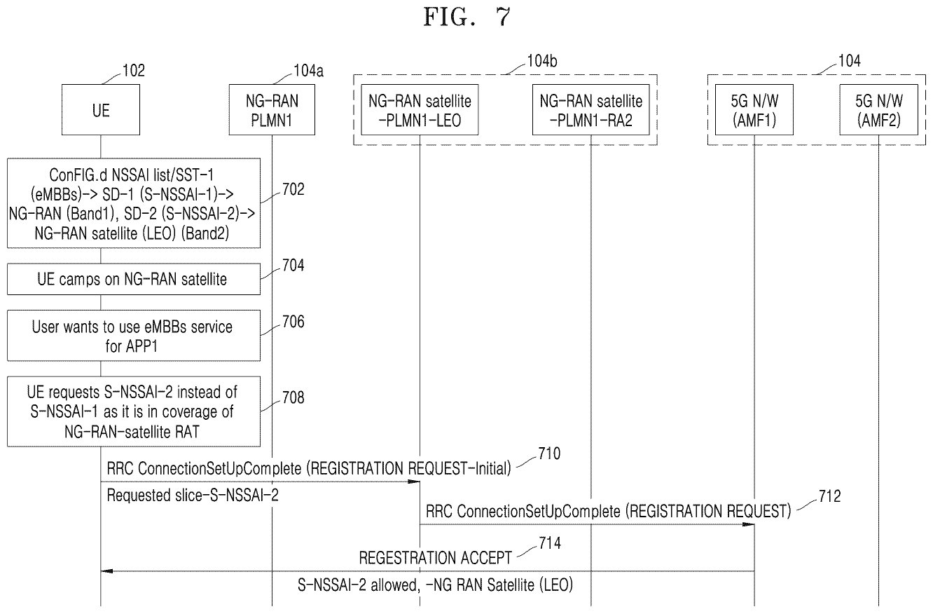

FIG. 7 is a sequence flow diagram illustrating a first solution scenario corresponding to the first problem scenario of FIG. 3, according to one or more embodiments. The sequence flow diagram may include several operations outlined as follows. The first solution scenario involves one or more following preconditions, as shown in Table 1A below.

TABLE 1A
Configured NSSAI- PLMN1

| | | |
|---|---|---|
| | | Band |
| Slice ID | Supported RAT | (Optional) |

Service or slice type - eMBBs

| | | |
|---|---|---|
| S-NSSAI1 | NG-RAN | 1 |
| S-NSSAI2 | NG-RAN satellite - LEO | 2 |

Service or slice type - urLLC

| | | |
|---|---|---|
| S-NSSAI4 | NG-RAN/NG-RAN satellite - | 3 |
| | LEO/GEO/MEO | |

Further, when the UE 102 is a multi-SIM UE, the solution may involve one or more following preconditions:

Configured NSSAI- PLMN1

| | | | |
|---|---|---|---|
| Slice ID | Supported RAT | Band (Optional) | SUPI |

Service or slice type - eMBBs

| | | | |
|---|---|---|---|
| S-NSSAI1 | NG-RAN | 1 | SUPI-1 |
| S-NSSAI2 | NG-RAN satellite - LEO | 2 | SUPI-2 |

Service or slice type - urLLC

| | | | |
|---|---|---|---|
| S-NSSAI4 | NG-RAN/NG-RAN satellite - | 3 | SUPI-2 |
| | LEO/GEO/MEO | | |

At operation 702, the UE 102 is configured with a network slice selection assistance information (NSSAI) list, which includes a Slice/service type (SST) 1 for enhanced mobile broadband service (eMBBS), a Slice differentiator (SD) 1 with single network slice selection assistance information (S-NSSAI) 1, which is supported on the next-generation radio access network (NG-RAN) with band 1, and a SD 2 with S-NSSAI 2, which is supported on the NG-RAN satellite network (low-earth orbit, LEO) with band 2. In particular, the UE 102 may include mapping information that indicates a relationship between a plurality of slices, and at least one of a plurality of RATs associated with one or more networks within the multi-RAT network environment 100.

At operations 704-708, when the UE 102 is camped on the NG-RAN satellite network 104b and wants to use eMBBs service for application 1, the UE requests S-NSSAI 2 instead of S-NSSAI 1, as the S-NSSAI 2 is within the coverage of the camped NG-RAN satellite network 104b.

At operation 710, in particular, since the slice services are mapped based on RAT and configured in the UE 102, the UE 102 may transmit an RRC connection setup complete message (registration request-initial) to the NG-RAN satellite (LEO) to access the S-NSSAI 2.

At operation 712, the NG-RAN satellite (LEO) forwards the received RRC connection setup complete message to the 5G network 104 (e.g., AMF-1).

At operation 714, upon reception of the RRC connection setup complete message, the 5G network 104 may send a registration accept message to the UE, indicating that S-NSSAI 2 is allowed on the NG-RAN satellite (LEO) network.

With this solution, the UE 102 has ability to select an appropriate S-NSSAI and/or the network slice based on its current location and available network capabilities, as configured in the UE's NSSAI list. The UE's ability to request the correct S-NSSAI and the network's response in accepting the request ensure a successful establishment of a desired service on the NG-RAN satellite.

In FIG. 7, in the first solution, slices are pre-configured with specific RAT information and provided to the UE 102 in the partial allowed and rejected S-NSSAI list. The UE 102 may avoid requesting slices that are not allowed in the specific RAT and can request services or slices only in the supported SUPIs and RATs.

In one or more embodiments, when the network 104 sends a registration accept message and provides RAT information for the slices that are allowed to be operated only in specific RATs and TAIs using the partially allowed S-NSSAI list, the UE 102 may use this information during PDU session establishment and mobility registration to register for those slices only in the allowed SUPI and RAT combinations, as well as the allowed TAIs.

In one or more embodiments, when a slice is not allowed in any of the TAIs of a specific RAT, the network 104 might indicate the slice is not allowed for the PLMN or standalone non-public network (SNPN) in the specific RAT using the partially rejected S-NSSAI list. The UE 102 may use this information to avoid requesting the slice in any of the registration areas (RAs) or TAIs for the same PLMN/SNPN/RedCap/B5G/6G where the RAT does not support it.

In one or more embodiments, the partially allowed and rejected S-NSSAI lists for RATs can be deleted when the UE 102 moves from the NG-RAN to the NG-RAN satellite network and vice versa. Additional information, such as SUPIs, RATs, bands, and location, can also be shared by the network with the UE 102 to assist the UE 102 in deciding the trigger of registration and selection for rejected slices. This enables effective and efficient utilization of resources and prevents delay in requested services.

In one or more embodiments, User Equipment Routing Selection Policy (URSP) rules may include band and RAT information, as well as SUPIs for the services or slices, and be shared with the UE 102 through NAS or downlink signaling messages. The UE 102 can use this information for PLMN/SNPN selection on the corresponding SUPIs and RATs, for selecting services or slice needs, and for PDU session activation of slices based on the supporting SUPIs and RATs. The URSP rules may be defined with S-NSSAI values to be attempted in different RATs, with the RAT type added in a Route Selection Descriptor (RSD) for the same traffic descriptors (e.g., application) to indicate which RAT the PDU session should be attempted first with the S-NSSAI values. If a corresponding application has support only for a specific RAT, the UE 102 may use this information during PLMN/SNPN selection and during PDU session establishment based on the supporting SUPIs and RATs.

In one or more embodiments, the RAT-specific mapping information that may steer the UE 102 to select the specific RATs/SUPIs may be included with a DL NAS message or a SOR container.

In FIG. 7, the aforementioned solution including the use of the partial allowed and rejected S-NSSAI lists, URSP rules, and RAT-specific information, is applicable for future RATs in 5G and 6G networks.

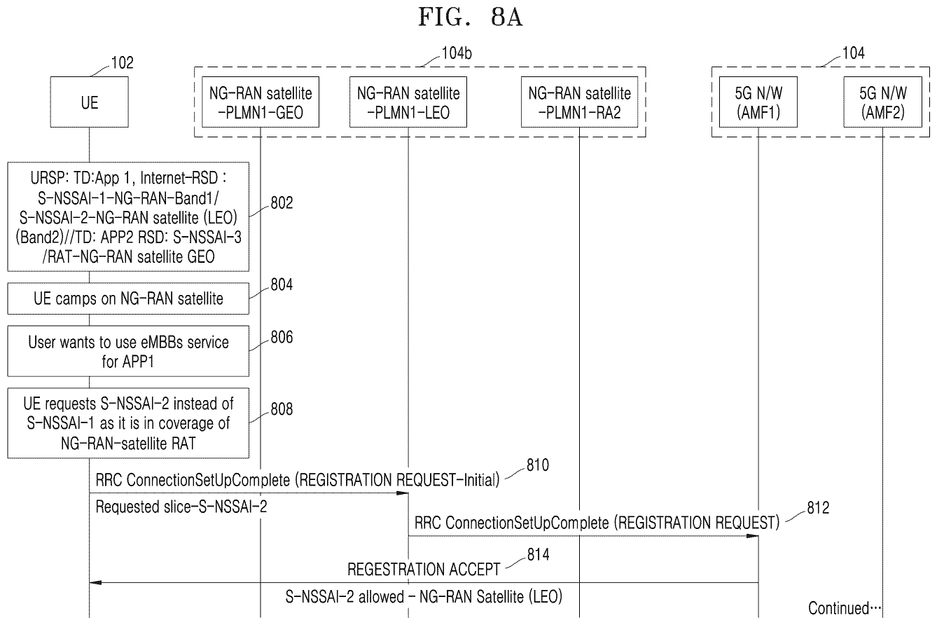

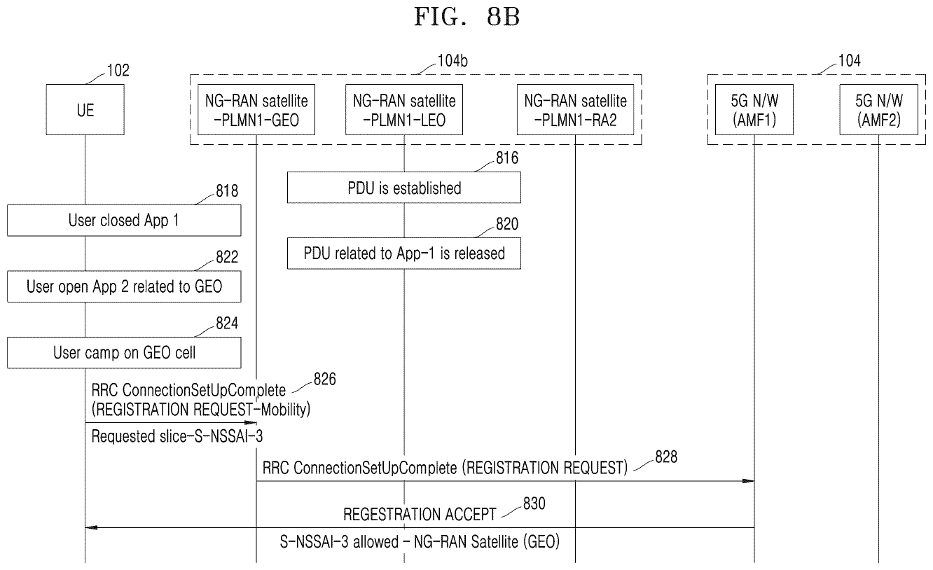

FIGS. 8A and 8B illustrate a second solution scenario. In FIGS. 8A and 8B, the solution may correspond to a solution to the first problem scenario explained in reference to FIG. 3. The sequence flow diagram may include several operations outlined as follows and involves one or more following preconditions, as shown in Table 2 below.

TABLE 2
URSP Rules
PLMN1

| Traffic Descriptors | RSD |
|---|---|
| Rule | Route selection |
| Precedence = 1 | Precedence = 1 |
| App1 | DNN: DNN1, |
| | Slice: S-NSSAI-1, |
| | Access: 3GPP, |
| | RAT: NG-RAN |
| | Band - 1 (Optional) |
| | ---------- |
| | Route selection |
| | Precedence = 2 |
| | DNN: DNN2, |
| | Slice: S-NSSAI-2, |
| | Access: 3GPP, |
| | RAT: NG-RAN satellite - LEO |
| | Band -2 (Optional) |
| Rule | Route selection |
| Precedence = 2 | Precedence = 1 |
| App2 | DNN: DNN3, |
| | Slice: S-NSSAI-3, |
| | Access: 3GPP, |
| | RAT: NG-RAN satellite - GEO |
| | Band -2 (Optional) |

In particular, the UE 102 may be configured with the URSP rules with RAT information either locally in a memory element corresponding to the UE 102 or in USIM installed within the UE 102. In another embodiment, the UE 102 may be configured with the URSP rules as shown in Table 2 via signaled URSP.

At operation 802, the UE 102 may be configured with the URSP, as discussed above.

The operations 804-814 are similar to operations 704-714, as explained in reference to FIG. 7, thus a detailed description of the same has been omitted.

At operations 802-814, the UE 102 camps on a coverage of the NG RAN satellite GEO-PLMN 1 (also referred to as HPLMN or Home Network). Further, the user of the UE 102 opens an App 1 which require service of slice type eMBBs. Since the slice services are mapped based on RAT and configured in the UE 102 as the URSP, the UE 102 sends S-NSSAI2 in Requested S-NSSAI correctly instead of S-NSSAI-1.

At operation 816, thus, a PDU connection is establish with S-NSSAI2 based on URSP evaluation to route traffic when camped on the NG-RAN satellite LEO.

At operation 818, however, the user closes App-1.

At operation 820, therefore, the PDU related to App-1 is now released.

At operation 822, the user opens App-2 which is related to NG-RAN satellite GEO.

At operation 824, the UE 102 camps on the GEO cell.

At operation 826, the UE 102 transmits a RRC connection setup complete message (Registration Request-Mobility) with the requested slice S-NSSAI 3 to the NG-RAN satellite-PLMN1-GEO.

At operation 828, the NG-RAN satellite (GEO) forwards the received RRC connection setup complete message to the 5G network 104 (e.g., AMF-1).

At operation 830, upon reception of the RRC connection setup complete message, the 5G network 104 may send a registration accept message to the UE 102, indicating that S-NSSAI 3 is allowed on the NG-RAN satellite (GEO) network. Thus, the UE 102 may be able to effectively and efficiently utilize resources associated with the UE 102 and the network 104 by utilizing the configured URSP rules for PLMN/SNPN selection.

In FIGS. 8A-8B, the aforementioned solution including the use of the URSP for PLMN/SNPN selection, is applicable for future RATs in 5G and 6G networks.

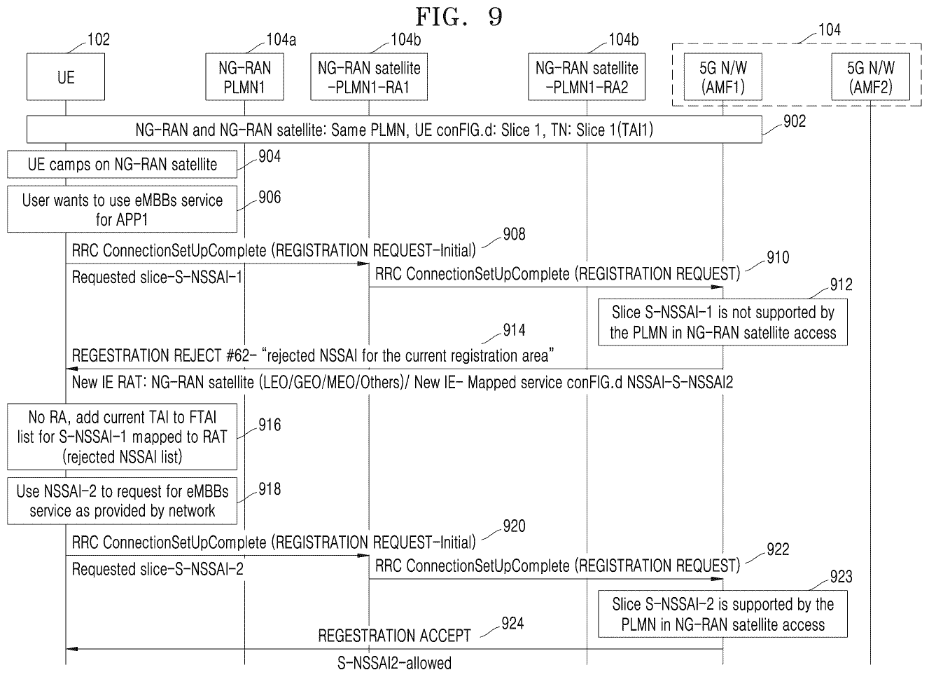

FIG. 9 illustrates a third solution scenario, according to one or more embodiments of the disclosure. The solution illustrated in FIG. 9 may correspond to a solution to the first problem scenario explained in reference to FIG. 3.

At operation 902, the NG-RAN (the TN 104a) and the NG-RAN satellite (the NTN 104b) may correspond to the same PLMN corresponding to the network 104. The UE 102 may be configured with slice 1 and the TN 104a may be configured to support the slice 1 (TAI1).

At operation 904, the UE 102 camps on the NG-RAN satellite (the NTN 104b).

At operation 906, the user of the UE 102 opens an App 1 which require service of slice type eMBBs.

At operation 908, the UE 102 may transmit an RRC connection setup complete message (registration request-initial) to the NG-RAN satellite (the NTN 104b) associated with PLMN1-RA1 to access the S-NSSAI 1.

At operation 910, the NG-RAN satellite (the NTN 104b) forwards the received RRC connection setup complete message to the network 104 (e.g., AMF-1).

At operation 912, upon reception of the RRC connection setup complete message, the network 104 may determine that slice S-NSSAI 1 is not supported by the PLMN in NG-RAN satellite access (the NTN 104b).

At operation 914, the network 104 sends a registration reject message to the UE 102. In one embodiment, the network 104 may transmit the registration reject message with reject clause #62 indicating “rejected NSSAI for current RA”. The registration reject message may also include a new information element (IE) indicating RATs and corresponding mapped services. For instance, the new ID may include “RAT: NG-RAN satellite (LEO/GEO/MEO/Others)/New IE-Mapped service configured NSSAI-S-NSSAI2”. In an alternative embodiment, the network 104 may accept the registration message and provides a new configured slice to be used in the NG-RAN satellite and S-NSSAI-1 in the rejected NSSAI list in a registration accept message.

At operation 916, the UE 102 with no RA, may add the TAI to an FTAI list for S-NSSAI-1 mapped to RAT in a rejected NSSAI list.

At operation 918, based on the information included in the new IE, the UE 102 may request eMBBs service as provided by the network 104.

In particular, the UE 102 may perform operations 920-922, similar to operations 908-910 to establish a connection with NG-RAN satellite (the NTN 104b) to access the S-NSSAI-2.

At operation 923, upon reception of the RRC connection setup complete message, the network 104 may determine that slice S-NSSAI 2 is supported by the PLMN in NG-RAN satellite access (the NTN 104b).

At operation 924, the network 104 may accept the registration request to allow the S-NSSAI-2 to access the UE 102. Thus, the UE 102 may be able to effectively access the requested services in the multi-RAT environment.

As illustrated in FIG. 9, the aforementioned solution including the use of the newly configured S-NSSAI to access the services, is applicable for future RATs in 5G, 6G, and future generation networks.

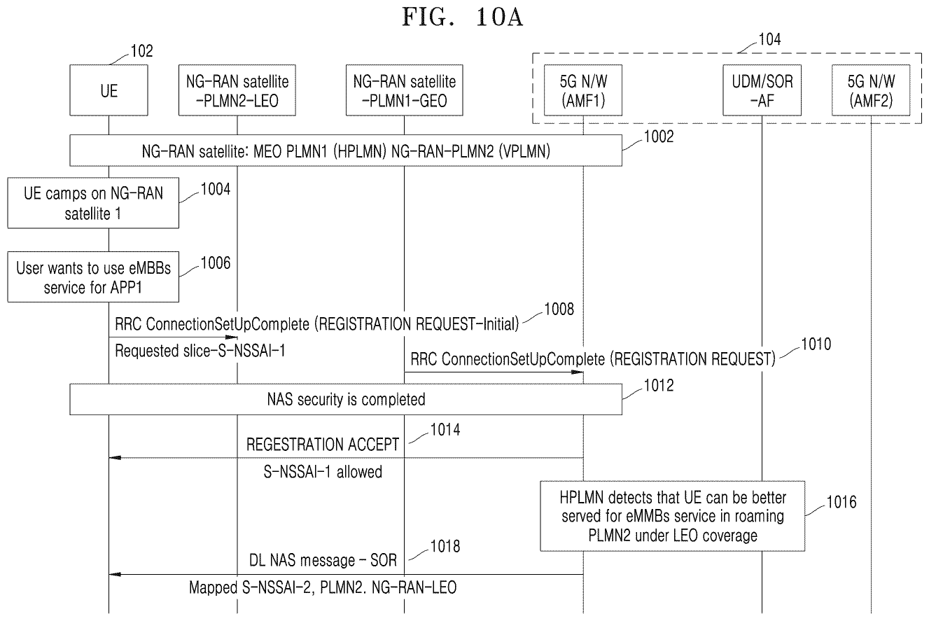

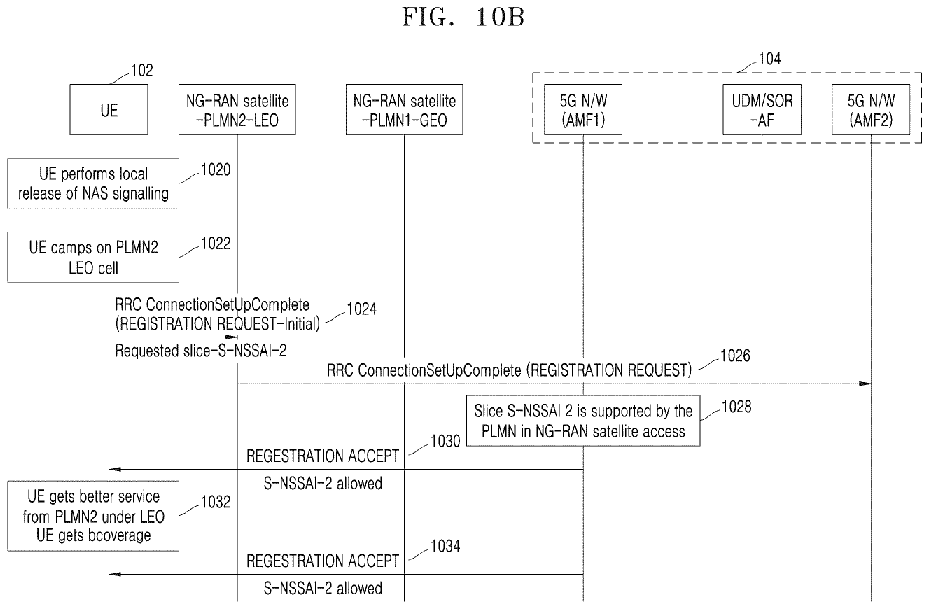

FIGS. 10A and 10B illustrate a fourth solution scenario, according to one or more embodiments of the disclosure. The fourth solution scenario is based on steering the UE based on the RAT. The solution illustrated in FIG. 9 may correspond to a solution to the first problem scenario explained in reference to FIG. 3. The sequence flow diagram may include several operations outlined as follows.

At operation 1002, in this solution scenario, the NG-RAN satellite (the NTN 104b) is associated with MEO PLMN (Home PLMN), and the NG-RAN (the TN 104a) is associated with PLMN2 (Visitors PLMN).

At operation 1004-1006, the UE 102 is camped on the NG-RAN satellite (the NTN 104b) and wants to use the eMBBs service for the application 1.

At operation 1008, the UE 102 transmits an RRC connection setup complete message (registration request-initial) to the NG-RAN satellite (GEO) (the NTN 104b) to access the S-NSSAI-1.

At operation 1010, the NG-RAN satellite (GEO) (the NTN 104b) forwards the received RRC connection setup complete message to the 5G network 104 (e.g., AMF-1).

At operation 1012, the UE 102 and the 5G network 104 complete the Non-Access Stratum (NAS) security procedures.

At operation 1014, upon successful NAS security procedures, the 5G network 104 sends a registration accept message to the UE 102, indicating that S-NSSAI-1 is an allowed S-NSSAI for the UE 102.

At operation 1016, the Home Public Land Mobile Network (HPLMN) detects that the UE 102 can be better served for eMBB services by roaming onto PLMN2 under LEO coverage.

At operation 1018, the 5G network 104 sends a Downlink NAS (DL-NAS) message, specifically a SOR message, to the UE 102, indicating that the mapped S-NSSAI2 is available on the PLMN2 NG-RAN-LEO network.

At operation 1020, the UE 102 performs a local release of the NAS signaling.

At operation 1022, as a result, the UE 102 camps on the PLMN2-LEO network.

At operation 1024, the UE 102 transmits an RRC connection setup complete message (registration request-initial) to the NG-RAN satellite (LEO) (the NTN 104b) to access the S-NSSAI-2 network slice.

At operation 1026, the NG-RAN satellite (LEO) forwards the received RRC connection setup complete message to the 5G network 104 (e.g., AMF-2).

At operation 1028, the 5G network 104 (e.g., AMF-1) detects that the S-NSSAI-2 network slice is supported by the PLMN in the NG-RAN satellite (the NTN 104b).

At operation 1030, the 5G network 104 (e.g., AMF-1) sends a registration accept message to the UE, indicating that S-NSSAI-2 is an allowed network slice selection assistance information for the UE 102.

At operation 1032, as a result, the UE 102 receives better service from the PLMN2 under LEO coverage.

At operations 1034, the 5G network (e.g., AMF-1) 104 sends additional registration accept messages to the UE 102, further confirming that S-NSSAI-2 is an allowed network slice selection assistance information.

In this solution, when the HPLMN detects that the UE 102 can be better served by the VPLMN under LEO coverage in the same location, the network 104 utilizes the SOR functionality/SOR information. Specifically, the 5G network 104 sends the DL-NAS message containing the SOR information to the UE 102. This SOR information indicates that the mapped S-NSSAI-2 is available on the PLMN2 NG-RAN-LEO network. Upon receiving the SOR information, the UE 102 releases the signaling connection locally and autonomously moves it to the PLMN2 network. Then, the UE 102 registers with the S-NSSAI-2 network slice, enabling it to receive better service compared to the previous GEO coverage network. The disclosed solution allows the network 104 to steer the UE 102 to the optimal PLMN and network slice, leveraging the advantages of LEO coverage, without requiring explicit UE involvement. The UE's local release of the signaling connection and autonomous registration on the PLMN2 network with the appropriate S-NSSAI improves the user experience by providing better service quality.

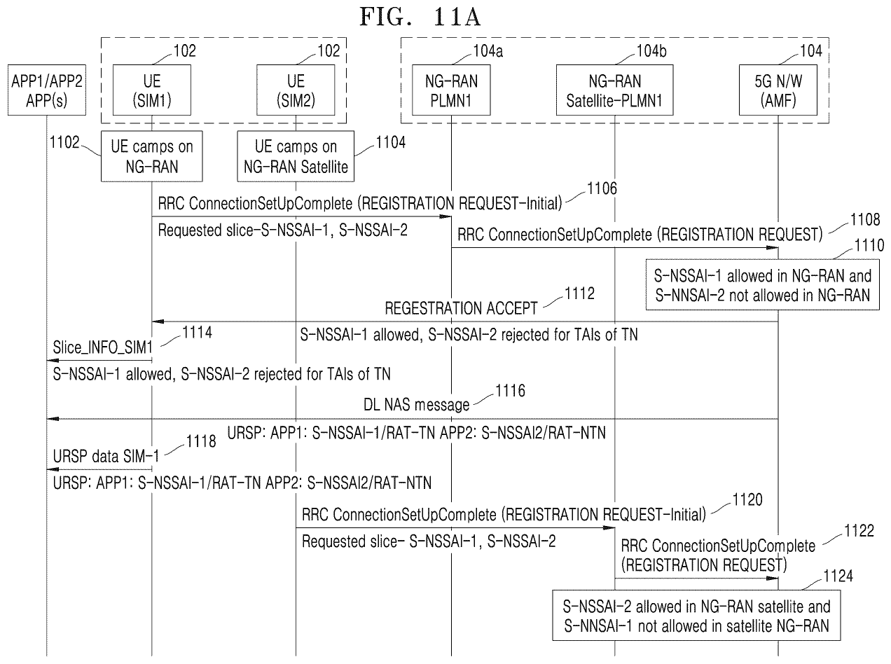

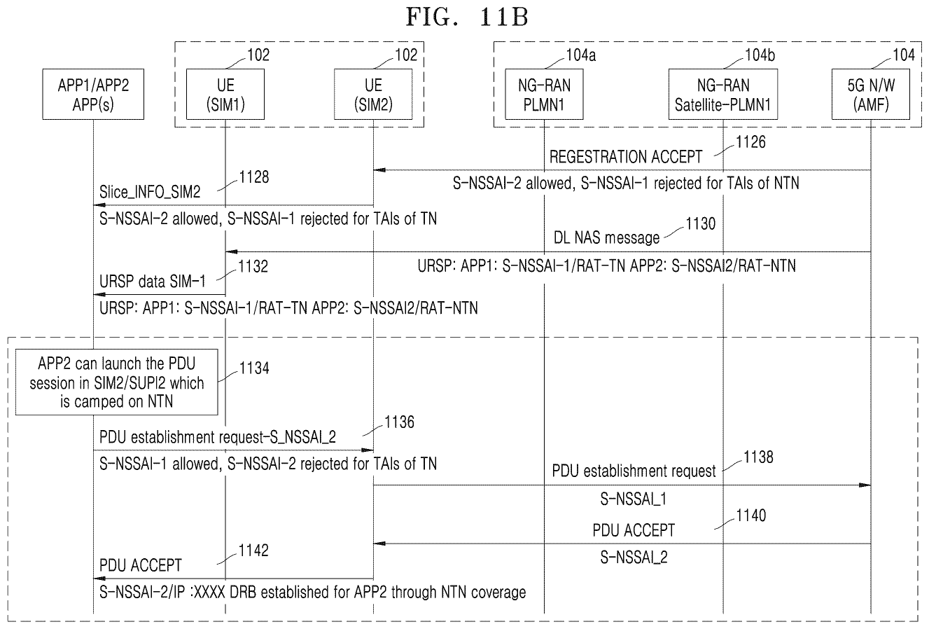

FIG. 11 illustrates fifth solution scenario, according to one or more embodiments of the disclosure. The fifth solution scenario is based URSP rules. FIG. 11 may correspond to a solution to the second problem scenario explained in reference to FIG. 4. The sequence flow diagram may include several operations outlined as follows.

In one or more embodiments, in scenarios where the required services or network slices are not available on a current SUPI or RAT of the UE 102, the UE 102 may trigger the necessary services on another SUPI or RAT within the UE 102.

In one or more embodiments, when the network 104 sends a registration accept message, the network 104 may provide RAT-specific information for the network slices that are only allowed to be operated on specific RATs and TAIs. The RAT specific information is conveyed through a partial allowed NSSAI list for the registered SUPI/RAT. The UE 102 and/or the application may utilize the RAT specific information during the PDU session establishment process. If the required services or slices are not available for the received SUPI/RAT, the UE 102 may trigger the service or slice registration in another SUPI or RAT.

In one or more embodiments, the network 104 may use a SOR container or a DL-NAS message to carry new Information Elements (IEs) that provide RAT-specific or SUPI-specific information to steer the UE 102 towards selecting the appropriate RAT or SUPI. The UE 102 may then use this information for PLMN or Stand-alone Non-Public Network (SNPN) selection, in order to access the services in another RAT or SUPI that are not supported by the current RAT or SUPI.

In one or more embodiments, the network 104 may update UE Route Selection Policy (URSP) rules to provide the RAT specific information. The URSP may include information such as band, RAT, SUPI, or Home Operator details for the specific services or slices. This information can be shared with the UE 102 through NAS or Downlink signaling messages. The UE 102 may utilize this information for PLMN or SNPN selection on the corresponding SUPIs or RATs, in order to select the required services or slices and initiate PDU session activation on another SUPI or RAT if the current RAT or SUPI does not support or has no configured traffic rules for the application. The aforementioned solution is applicable for future RATs in 5G and 6G networks.

In one or more embodiments, another solution is URSP-based slice and RAT selection along with one or more preconditions, as mentioned below.

The UE 102 may be configured with one or more URSP rules that include information about network slices, RATs, SUPIs, and HPLMN information. The information can be stored locally on the UE 102, provisioned in the USIM, or signaled to the UE 102 through network signaling.

The URSP rules are structured as shown in Table X and Table Y, providing the necessary details for the UE to make informed decisions about slice and RAT selection.

TABLE X
URSP Rules - SUPI1
PLMN1

| Traffic Descriptors | RSD |
|---|---|
| Rule | Route selection Precedence = 1 |
| Precedence = 1 | DNN: DNN1, |
| App1 | Slice: S-NSSAI-1, |
| | Access : 3GPP, |
| | RAT: NG-RAN |
| | SUPI: SUPI1 |
| | HPLMN: PLMN1 |
| | Band - 1 (Optional) |
| | ---------- |
| | Route selection Precedence = 2 |
| | DNN: DNN2, |
| | Slice: S-NSSAI-2, |
| | Access: 3GPP, |
| | RAT: NG-RAN satellite - LEO |
| | SUPI: SUPI2 |
| | HPLMN: PLMN1 |
| | Band -2 (Optional) |
| Rule | Route selection Precedence = 1 |
| Precedence = 2 | DNN: DNN3, |
| App2 | Slice: S-NSSAI-3, |
| | Access: 3GPP, |
| | RAT: NG-RAN satellite - GEO |
| | SUPI: SUPI2 |
| | HPLMN: PLMN1 |
| | Band-2 (Optional) |

TABLE Y
URSP Rules - SUPI2
PLMN1

| Traffic Descriptors | RSD |
|---|---|
| Rule | Route selection Precedence = 1 |
| Precedence = 1 | DNN: DNN1, |
| App1 | Slice: S-NSSAI-1, |
| | Access: 3GPP, |
| | RAT: NG-RAN |
| | SUPI: SUPI1 |
| | HPLMN: PLMN1 |
| | Band - 1 (Optional) |
| | Route selection Precedence = 2 |
| | DNN: DNN2, |
| | Slice: S-NSSAI-2, |
| | Access: 3GPP, |
| | RAT: NG-RAN satellite - LEO |
| | SUPI: SUPI2 |
| | HPLMN: PLMN1 |
| | Band -2 (Optional) |
| Rule | Route selection Precedence = 1 DNN: DNN3, |
| Precedence = 2 | Slice: S-NSSAI-3, |
| App2 | Access: 3GPP, |
| | RAT: NG-RAN satellite - GEO |
| | SUPI: SUPI2 |
| | HPLMN: PLMN1 |
| | Band -2 (Optional) |

The proposed solution as illustrated in FIG. 11 (URSP-based solution) may involve following preconditions. First, the UE has two SUPIs or SIM cards active, each with a separate subscription. Second, the UE is configured with two network slices. Slice-1 is only served by the TN. Slice-2 is only served by the NTN. Third, the applications running on the UE are mapped to the respective network slices as follows: Application 1 (App 1) is mapped to the slice-1. Application 2 (App 2) is mapped to the slice-2.

The sequence flow diagram as shown in FIG. 11 may include several operations outlined as follows.

In the URSP-based solution, at operation 1102-1106, the UE 102 camps on the NG-RAN (the TN 104a) by utilizing the functionality of the SIM-1 and the UE 102 camps on the NG-RAN satellite (the NTN 104b) by utilizing the functionality of the SIM-2, by transmitting the RRC connection setup complete message (registration request-initial) to access the S-NSSAI-1 and an S-NSSAI-2.

At operations 1108, the NG-RAN (the TN 104a) forwards the received RRC connection setup complete message to the 5G network 104 (e.g., AMF).

At operations 1110, upon reception of the RRC connection setup complete message, the 5G-network 104 detects that the S-NSSAI-1 is supported by the NG-RAN and the S-NSSAI-2 is not supported by the NG-RAN.

At operation 1112, upon detection, the 5G network 104 sends a registration accept message to the UE (SIM-1), where the registration accept message indicates that the S-NSSAI-1 is allowed/supported by the NG-RAN and the S-NSSAI-2 is rejected for TAIs of the TN.

At operation 1114, the UE 102 (SIM-1) sends a slice info SIM-1 message to the applications, where the slice info SIM-1 message indicates that the S-NSSAI-1 is allowed/supported by the NG-RAN and the S-NSSAI-2 is rejected for TAIs of the TN.

At operation 1116, the 5G-network 104 sends the DL-NAS message to the SIM-1, where the DL-NAS message contains the URSP information, which indicates the following information. First, for Application 1 (APP-1), the allowed S-NSSAI is S-NSSAI-1, and the allowed RAT is the RAT-TN. Second, for Application 2 (APP-2), the allowed S-NSSAI is S-NSSAI-2, and the allowed RAT is the RAT-NTN.

At operation 1118, the SIM-1 forwards the received URSP information to the applications running on the UE 102, as a URSP data-SIM-1. The URSP information allows the applications to make informed decisions about the appropriate network slice and RAT selection for their respective service requirements. The UE 102 may then utilize this policy information to initiate PDU session establishment (refer to the operation 1134), based on the application's needs and the available network capabilities.

At operation 1120, the UE transmits an RRC connection setup complete message (registration request-initial) to the NG-RAN satellite to access the S-NSSAI-1 and the S-NSSAI-2. At operations 1122, the NG-RAN satellite forwards the received RRC connection setup complete message to the 5G-NW (e.g., AMF). At operations 1124, upon reception of the RRC connection setup complete message, the 5G network 104 detects that the S-NSSAI-2 is supported by the NG-RAN satellite and the S-NSSAI-1 is not supported by the NG-RAN satellite.

At operation 1126, upon detection, the 5G network 104 sends a registration accept message to the UE 102 (SIM-1), where the registration accept message indicates that the S-NSSAI-1 is allowed/supported by the NG-RAN and the S-NSSAI-2 is rejected for TAIs of the TN. At operation 1128, the UE 102 (SIM-1) sends a slice info SIM-2 message to the applications, where the slice info SIM-2 message indicates that the S-NSSAI-2 is allowed/supported by the NG-RAN and the S-NSSAI-1 is rejected for TAIs of the NTN.

At operation 1130, the 5G network 104 sends the DL-NAS message to the SIM-1, where the DL-NAS message contains the URSP information, which indicates the following information. First, for Application 1 (APP-1), the allowed S-NSSAI is S-NSSAI-1, and the allowed RAT is the RAT-TN. Second, for Application 2 (APP-2), the allowed S-NSSAI is S-NSSAI-2, and the allowed RAT is the RAT-NTN.

At operation 1132, the SIM-1 forwards the received URSP information to the applications running on the UE 102, as a URSP data-SIM-1. The URSP information allows the applications to make informed decisions about the appropriate network slice and RAT selection for their respective service requirements. The UE 102 may then utilize this policy information to initiate PDU session establishment (refer to the operation 1134), based on the application's needs and the available network capabilities.

At operation 1134, the application-2 launches the PDU session in the SIM-2/SUPI-2, which is camped on the NTN.

At operation 1136, the application (e.g., application-2) sends a PDU session establishment request for the S-NSSAI-2 to the SIM-2.

At operation 1138, the SIM-2 sends the PDU session establishment request to the 5G-NW.

At operations 1140-1142, upon receiving the PDU session establishment request, the 5G-NW sends a PDU accept message to the application via the SIM-2, which triggers the establishment of a Data Radio Bearer (DRB) for the Application-2 through the NTN coverage. The aforementioned sequence of operations allows the Application-2, which is mapped to the S-NSSAI-2 slice, to successfully establish the PDU session and associated DRB over the NTN coverage. The use of the SIM-2/SUPI-2 and the 5G-NW response enables the application to access the required network resources and services through the appropriate NTN.

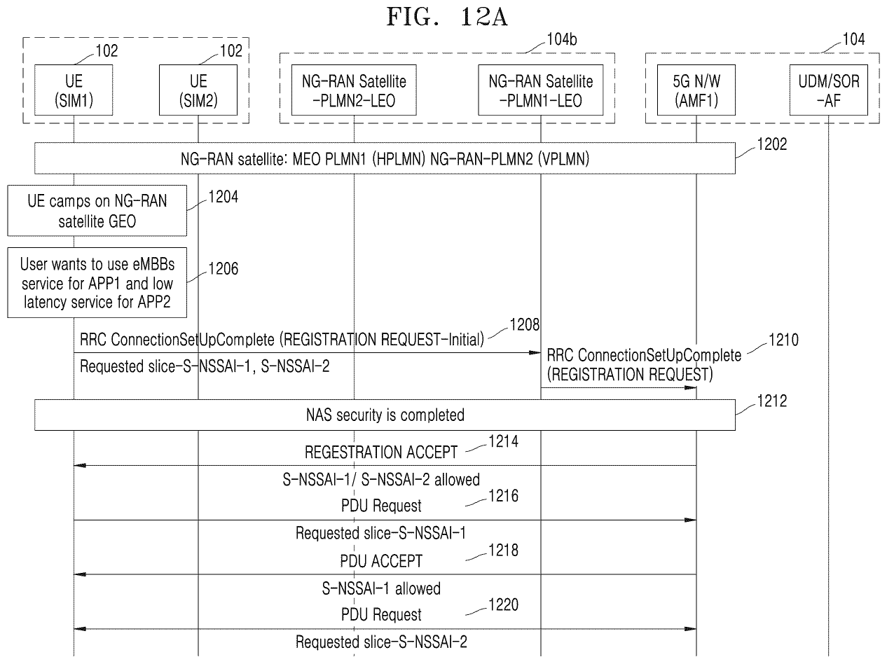

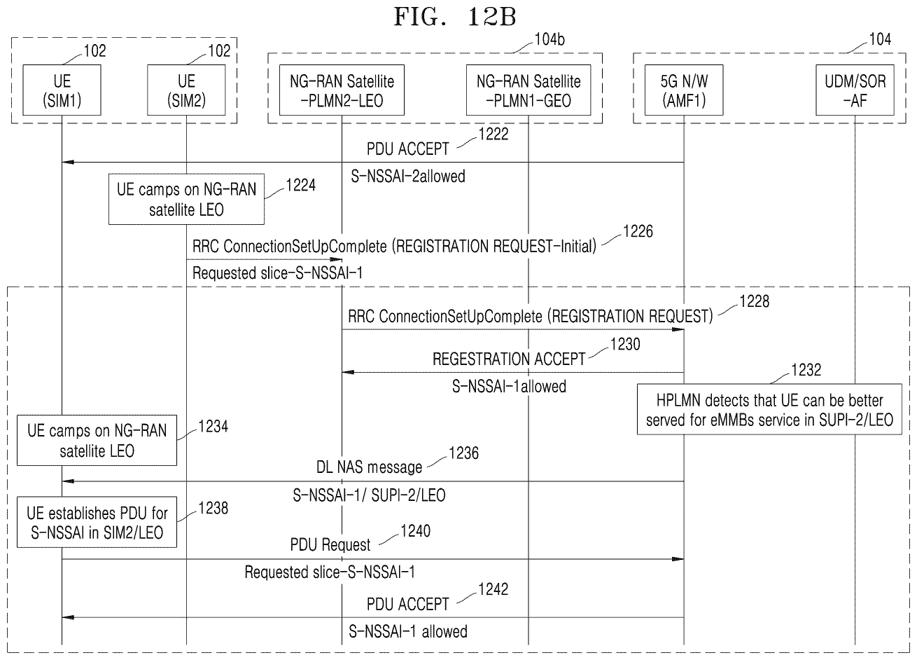

FIGS. 12A-12B illustrate a second solution scenario (steering based solution), according to one or more embodiments. FIG. 12A-12B may correspond to a solution to the second problem scenario explained in reference to FIG. 4. The sequence flow diagram may include several operations outlined as follows.

In the steering based solution, at operation 1202, the NG-RAN satellite is associated with MEO PLMN (HPLMN) and the NG-RAN is associated with PLMN2 (VPLMN).

At operation 1204-1206, the UE 102 (SIM-1) is camped on the NG-RAN satellite (GEO) and wants to use the eMBBs service for the application 1 and low latency service for the application 2.

At operation 1208, the UE 102 (SIM-1) transmits an RRC connection setup complete message (registration request-initial) to the NG-RAN satellite (GEO) to access the S-NSSAI-1 and the S-NSSAI-2.

At operation 1210, the NG-RAN satellite (GEO) forwards the received RRC connection setup complete message to the 5G network 104 (e.g., AMF-1).

At operation 1212, the UE 102 and the 5G network 104 complete the Non-Access Stratum (NAS) security procedures.

At operation 1214, upon successful NAS security procedures, the 5G network 104 sends a registration accept message to the UE 102, indicating that S-NSSAI-1 and the S-NSSAI-2 are an allowed S-NSSAI for the UE 102.

At operation 1216, the UE 102 (SIM-1) sends a PDU request to the 5G network 104 for accessing the S-NSSAI-1.

At operation 1218, in response to the PDU request, the UE 102 (SIM-1) receives a PDU accept message from the 5G network 104.

At operation 1220, the UE 102 (SIM-1) sends a PDU request to the 5G network 104 for accessing the S-NSSAI-2.

At operation 1222, in response to the PDU request, the UE 102 (SIM-1) receives a PDU accept message from the 5G network 104.

At operation 1224, the UE 102 (SIM-2) is camped on the NG-RAN satellite (LEO).

At operation 1226, the UE 102 (SIM-2) transmits an RRC connection setup complete message (registration request-initial) to the NG-RAN satellite (LEO) to access the S-NSSAI-1.

At operation 1228, the NG-RAN satellite (LEO) forwards the received RRC connection setup complete message to the 5G network 104 (e.g., AMF-1).

At operation 1230, the 5G network 104 sends the registration accept message to the UE 102 (SIM-2), which indicates that the UE 102 may access the S-NSSAI-1.

At operation 1232, the HPLMN detects that the UE 102 may be better served for eMBB services using the SUPI-2 subscription and the LEO network.

At operation 1234, the UE 102 camps on the NG-RAN Satellite operating in the GEO network.

At operation 1236, the UE 102 receives the DL-NAS message from the 5G network 104, which contains information about the S-NSSAI-1 network slice, the SUPI-2 subscription, and the LEO network.

At operation 1238, the UE 102 establishes the PDU session for the S-NSSAI-1 using the SIM-2/SUPI-2 subscription and the LEO network.

At operation 1240, the UE 102 (using the SIM-2/SUPI-2) sends a PDU session establishment request to the 5G network for the S-NSSAI-1 network slice.

At operation 1242, the UE 102 (using the SIM-2/SUPI-2) receives the PDU session establishment accept from the 5G network 104, which indicates that the UE is allowed to access the S-NSSAI-1 network slice.

The aforementioned sequence of operations demonstrates the UE's ability to leverage the HPLMN's detection of better eMBB service availability using the SUPI-2 subscription and LEO network. The UE's reception of the DL-NAS message, establishment of the PDU session, and subsequent signaling with the 5G network enable the UE to access the S-NSSAI-1 network slice through the optimal SUPI-2 and LEO network combination, as recommended by the HPLMN.

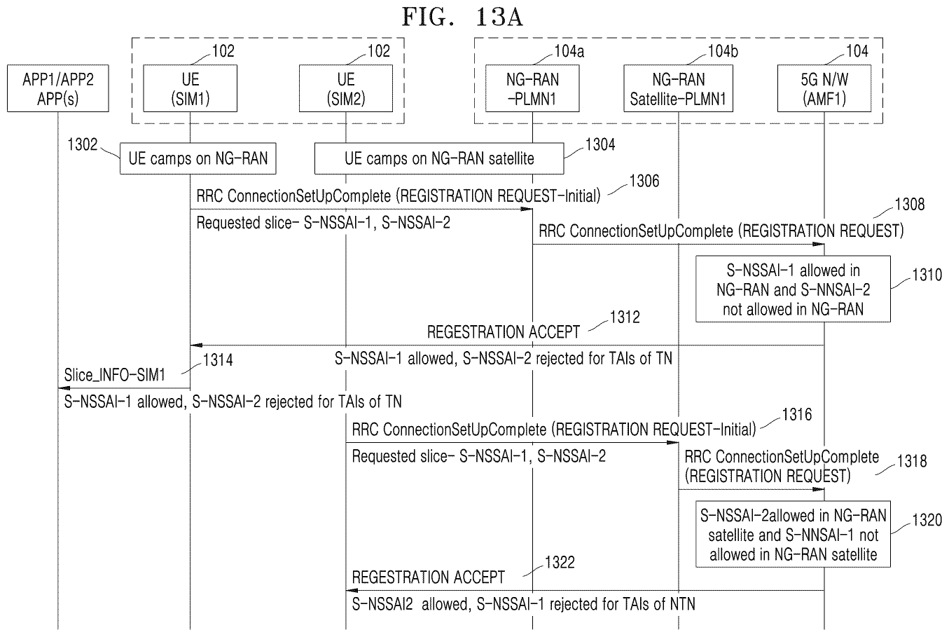

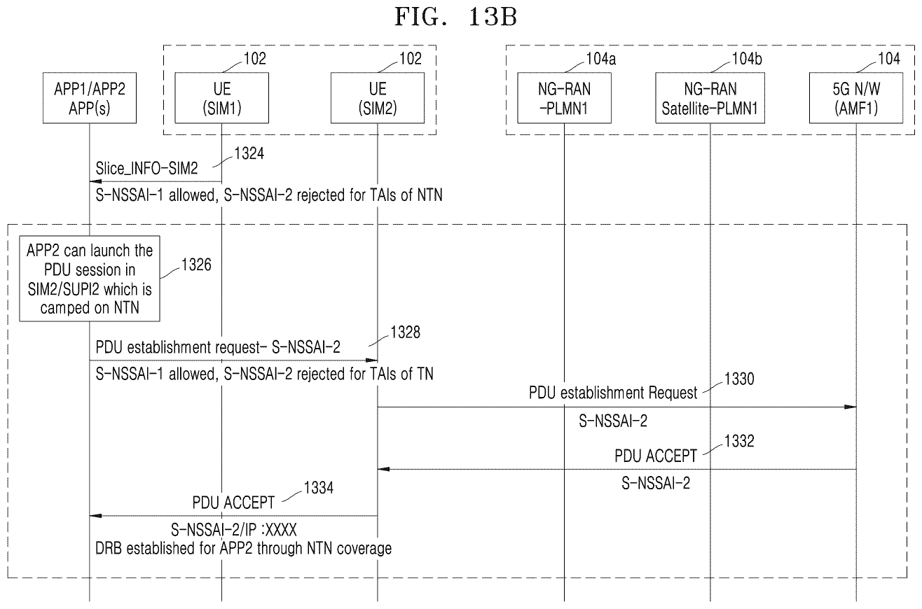

FIGS. 13A and 13B illustrate a third solution scenario (NAS signaling based), according to one or more embodiments. FIGS. 13A-13B may correspond to a solution to the second problem scenario explained in reference to FIG. 4. The sequence flow diagram may include several operations outlined as follows.

In the NAS signaling based, at operation 1302-1306, the UE 102 camps on the NG-RAN (the TN 104b) by utilizing the functionality of the SIM-1 and the UE camps on the NG-RAN satellite (the NTN 104b) by utilizing the functionality of the SIM-2, by transmitting the RRC connection setup complete message (registration request-initial) to access the S-NSSAI-1 and an S-NSSAI-2.

At operations 1308, the NG-RAN forwards the received RRC connection setup complete message to the 5G-network 104 (e.g., AMF).

At operations 1310, upon reception of the RRC connection setup complete message, the 5G network 104 detects that the S-NSSAI-1 is supported by the NG-RAN and the S-NSSAI-2 is not supported by the NG-RAN.

At operation 1312, upon detection, the 5G network sends a registration accept message to the UE 102 (SIM-1), where the registration accept message indicates that the S-NSSAI-1 is allowed/supported by the NG-RAN and the S-NSSAI-2 is rejected for TAIs of the TN.

At operation 1314, the UE 102 (SIM-1) sends a slice info SIM-1 message to the applications, where the slice info SIM-1 message indicates that the S-NSSAI-1 is allowed/supported by the NG-RAN and the S-NSSAI-2 is rejected for TAIs of the TN.

At operation 1316, the UE 102 (SIM-2) transmits an RRC connection setup complete message (registration request-initial) to the NG-RAN satellite to access the S-NSSAI-1 and the S-NSSAI-2.

At operations 1318, the NG-RAN satellite forwards the received RRC connection setup complete message to the 5G-network 104 (e.g., AMF).

At operations 1320, upon reception of the RRC connection setup complete message, the 5G network 104 detects that the S-NSSAI-2 is supported by the NG-RAN satellite and the S-NSSAI-1 is not supported by the NG-RAN satellite.

At operation 1322, upon detection, the 5G network 104 sends a registration accept message to the UE (SIM-2), where the registration accept message indicates that the S-NSSAI-1 is allowed/supported by the NG-RAN and the S-NSSAI-2 is rejected for TAIs of the TN.

At operation 1324, the UE 102 (SIM-1) sends a slice info SIM-2 message to the applications, where the slice info SIM-2 message indicates that the S-NSSAI-2 is allowed/supported by the NG-RAN and the S-NSSAI-1 is rejected for TAIs of the NTN.

At operation 1326, the application-2 launches the PDU session in the SIM-2/SUPI-2, which is camped on the NTN.

At operation 1328, the application (e.g., application-2) sends a PDU session establishment request for the S-NSSAI-2 to the SIM-2.

At operation 1330, the SIM-2 sends the PDU session establishment request to the 5G-NW.

At operations 1332-1334, upon receiving the PDU session establishment request, the 5G network 104 sends a PDU accept message to the application via the SIM-2, which triggers the establishment of a Data Radio Bearer (DRB) for the Application-2 through the NTN coverage. Aforementioned sequence of operations allows the Application-2, which is mapped to the S-NSSAI-2 slice, to successfully establish the PDU session and associated DRB over the NTN coverage. The use of the SIM-2/SUPI-2 and the 5G-NW's response enable the application to access the required network resources and services through the appropriate NTN.

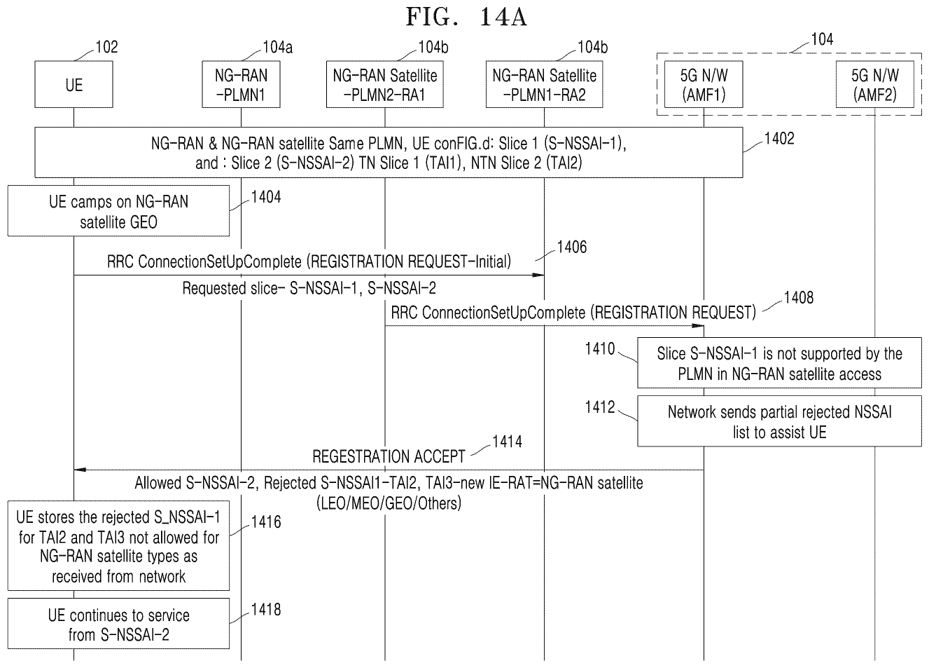

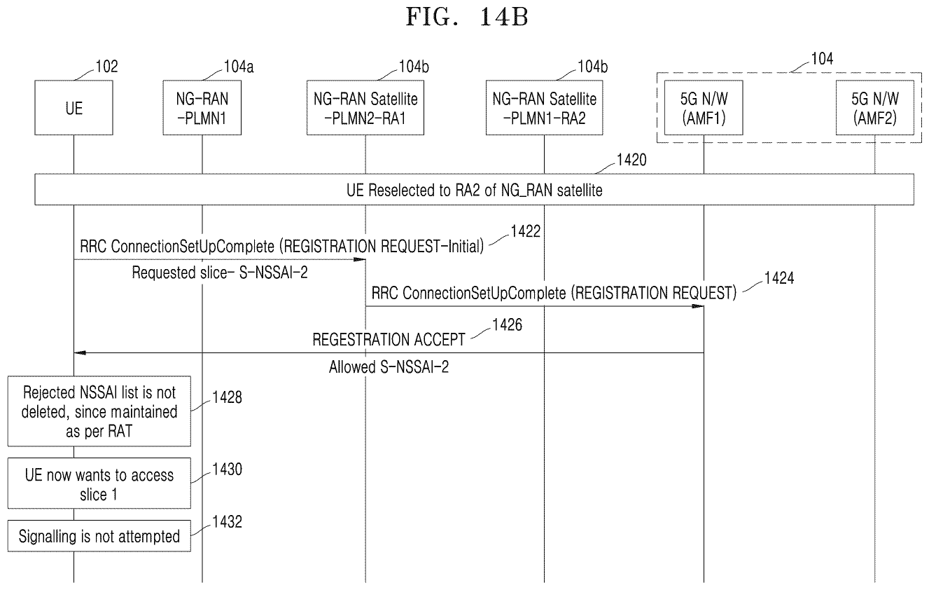

FIGS. 14A and 14B illustrate a solution scenario corresponding to the third problem scenario of FIG. 5, according to one or more embodiments of the disclosure. The sequence flow diagram may include several operations outlined as follows. The proposed solution as illustrated in FIGS. 14A and 14B may involve following two preconditions. First, Slice-1 and Slice-2 are configured for the UE. Second, Slice-1 is supported in the TN TAIs and Slice-2 is supported by NTN TAIs (i.e., TN-TAI1/NTN-TAI2, TAI3).

The abovementioned preconditions are highlighted as operation 1402.

At operation 1404, the UE 102 camps on the NG-RAN satellite (the NTN 104b).

At operation 1406, the UE 102 may transmit an RRC connection setup complete message (registration request-initial) to the NG-RAN satellite network 104b to access the S-NSSAI 1 and S-NSSAI-2.

At operation 1408, the NG-RAN satellite forwards the received RRC connection setup complete message to the 5G network 104 (e.g., AMF-1).

At operation 1410, upon reception of the RRC connection setup complete message, the 5G network 104 may determine that the slice S-NSSAI-1 is not supported by the PLMN in NG-RAN satellite access.

At operation 1412, thus, the 5G network 104 may send partially rejected NSSAI list to assist the UE 102.

At operation 1414, the network 104 sends a registration accept message to the

UE 102, indicating that S-NSSAI 2 is allowed, and the S-NSSAI-1 is rejected. Further, the registration accept message include a new IE indicating S-NSSAI-1 support.

At operation 1416, the UE 102 may store the rejected S_NSSAI-1 for TAI2 and TAI3 not allowed for NG-RAN satellite types as received from network 104.

At operation 1418, the UE 102 may continue to receive services from the S-NSSAI-2.

At operation 1420, the UE 102 reselects to the RA2 of the NG-RAN satellite.

At operations 1422-1426, the UE 102 may perform the RRC connection establishment.

At operation 1426, the UE 102 may receive a registration accept message indicating the requested S-NSSAI-2 is allowed.

At operation 1428, the rejected NSSAI list is not deleted and maintained per RAT basis.

At operation 1430, the UE 102 wants to access Slice-1.

At operation 1432, however, signaling is not attempted based on the stored rejected NSSAI list.

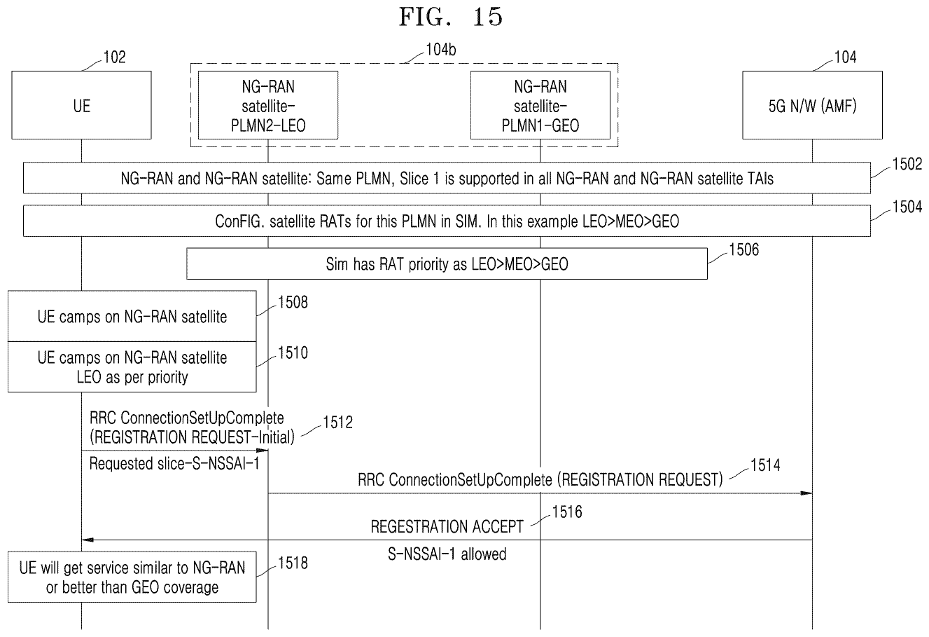

FIG. 15 illustrates a solution scenario corresponding to the fourth problem scenario of FIG. 6, according to one or more embodiments of the disclosure. The solution scenario is based on defined priority of RATs at the UE 102. The sequence flow diagram may include several operations outlined as follows.

At operation 1502, the NG-RAN (the TN 104a) and the NG-RAN satellite (the NTN 104b) may correspond to a same PLMN associated with the network 104. Moreover, a slice 1 is supported by all the NG-RAN (the TNs 104a) and the NG-RAN satellite TAIs (the NTN 104b).

At operation 1504, the NG-RAN satellite TAIs is configured in the SIM associated with the UE 102 with a corresponding priority of each of the NG-RAN satellite type. For example, a priority may be defined for the NG-RAN Satellite LEO, the NG-RAN satellite MEO, and the NG-RAN satellite GEO, where the NG-RAN Satellite LEO may be given a highest priority, and the NG-RAN satellite GEO may be given a lowest priority.

Operation 1506 may indicate that the above-mentioned priorities may be defined at the SIM associated with the UE 102.

At operation 1508, the UE 102 may camp on the NG-RAT satellite (the NTN 104b) for the required services/slices.

At operation 1510, the UE 102 may camp on the NG-RAN satellite LEO instead of NG-Satellite GEO as per the priority stored at the UE 102.

At operation 1512, the UE 102 may transmit an RRC connection setup complete message (registration request-initial) to the NG-RAN satellite (LEO) to access the S-NSSAI 1.

At operation 1514, the NG-RAN satellite (LEO) forwards the received RRC connection setup complete message to the 5G network 104 (e.g., AMF-1).

At operation 1516, upon reception of the RRC connection setup complete message, the 5G network 104 may send a registration accept message to the UE, indicating that S-NSSAI 1 is allowed on the NG-RAN satellite (LEO) network.

At operation 1518, thus, the UE 102 may get better services as compared to GEO coverage.

The SIM has RAT priority defined in order where the NG-RAN satellite GEO is given a highest priority and the NG-RAN satellite MEO is given a lowest priority, the UE 102 may camp on the NG-RAN satellite GEO to avoid the services. The priorities of the different types of RAT may be defined based on factors such as, but not limited to, a location of the UE, a PLMN, a HPLMN, a subscription the UE 102, and so forth. Moreover, if each of the RAT type is given same priority. The UE 102 may prioritize the NG-RAN satellite LEO over the NG-RAN satellite GEO or the NG-RAN satellite MEO.

In one embodiment, the UE 102 may store the priority information in a USIM files such as, an Elementary File user controlled PLMN with Access Technology (EFPLMNWACT) file, an Elementary File operator controlled PLMN with Access Technology (EFOPLMNWACT) file, an elementary file home PLMN selector with Access Technology (EFHPLMNWACT) file, etc. Such a USIM file may specify a detailed support NG-RAN satellite supported RAT types and corresponding priorities. Thus, when a PLMN supports all NG-RAN satellite RAT type priority setting shall be taken into consideration to ensure latency is reduced. However, in case the priorities of different RAT types are not defined, the UE 102 may select the PLMN in a RAT the following order: NG-RAN>NG-RAN satellite LEO>NG-RAN satellite MEO>NG-RAN satellite GEO.

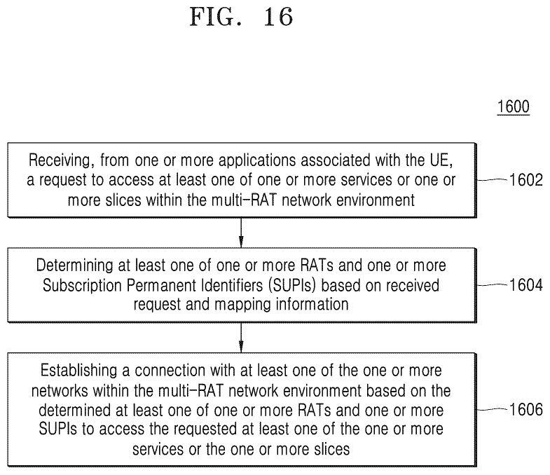

FIG. 16 illustrates a method for accessing one or more services by the UE 102 in a multi-RAT network environment 100.

At operation 1602, the method 1600 may include receiving, from one or more applications associated with the UE 102, a request to access at least one of one or more services or one or more slices within the multi-RAT network environment 100.

At operation 1604, the method 1600 may include determining at least one of one or more RATs and one or more Subscription Permanent Identifiers (SUPIs) based on received request and mapping information. The mapping information indicates a relationship between a plurality of slices, and at least one a plurality of RATs associated with one or more networks within the multi-RAT networks or a plurality of SUPIs stored at the UE 102. In an embodiment, the mapping information may include, but not limited to, a User Equipment Routing Selection Policy (URSP), an Access Network Discovery and Selection Policy (ANDSP) or Home Network configured or controlled policy for selecting RAT based on services or slices, a configured Network Slice Selection Assistance Information (NSSAI), an allowed NSSAI, an alternative NSSAI, a slice or service priority, a supported-band related information, a SUPI, and a location associated with each of the one or more RATs within the multi-RAT environment for Public Land Mobile Networks PLMNs/Standalone Non-Public Networks (SNPNs).

In one embodiment, to determining the at least one of one or more RATs and one or more SUPIs, the method 1600 may include establishing a connection with at least one of the one or more networks within the multi-RAT network environment 100. Thereafter, the method 1600 may include transmitting the request to the at least one of the one or more network to access the at least one of the one or more services or one or more the slices. Further, the method 1600 may include receiving a response message comprising an indication of one of rejection or acceptance of the at least one of the one or more services or one or more the slices and the mapping information.

Specifically, in one embodiment, the mapping information may be preconfigured at the UE 102. For instance, the mapping information may be stored in a memory element of the UE 102 or the USIM of the UE 102. The mapping information may be stored at the UE 102 by a network operator. In an alternative embodiment, the mapping information may be provided by the network 104 to the UE 102 via any suitable signaling message such as, but not limited to, DL NAS signaling, SOR container, registration request message, etc.

In some embodiments, the method 1600 may also include maintaining a list of networks and associated Tracking Area Identity (TAI) RAT and access environment including a SNPN, REDCAP network, TN, NTN, Beyond-5G (B5G), 6G, based on the received response message with the indication of the rejection of the at least one of the one or more services or one or more the slices. The method 1600 may also include avoiding the access to any network based on the information included in the list of networks.

At operation 1606, the method 1600 may include establishing a connection with at least one of the one or more networks within the multi-RAT network environment based on the determined at least one of one or more RATs and one or more SUPIs to access the requested at least one of the one or more services or the one or more slices. Further, in one embodiment, the method 1600 may include identifying at least one or more services or slices not supported in a current RAT or a SUPI based on the response message or the mapping information. Thereafter, the method 1600 may include establishing a second connection via the one or more determined RATs or the one or more SUPIs to access the one or more identified services or slices.

In one or more embodiments, the one or more RATs may include, but not limited to, a 5G NTN or a 5G TN, and wherein priorities of the one or more RATs may be pre-configured in at least one of an Elementary File user controlled PLMN with Access Technology (EFPLMNWACT) file, an Elementary File operator controlled PLMN with Access Technology (EFOPLMNWACT) file, an elementary file home PLMN selector with Access Technology (EFHPLMNWACT) file, or a memory element of the UE, and the priorities of the one or more RATs are mapped to one or more services or one or more slices in the mapping information.

In one or more embodiments, the UE can also take additional operations like changing from one access mode to another access mode before attempting the connection to network. For example, when operating in PLMN access mode, access to SNPN networks is not allowed. Similarly, when operating in SNPN access mode, access to PLMNs is not allowed. So, if certain slice or service is possible on certain access only as configured in UE or indicated by network to UE then UE can change to corresponding access mode to avail the services.

Embodiments are exemplary in nature and the operations of the method 1600 as shown in FIG. 16 may occur in variations to the sequence in accordance with various embodiments.

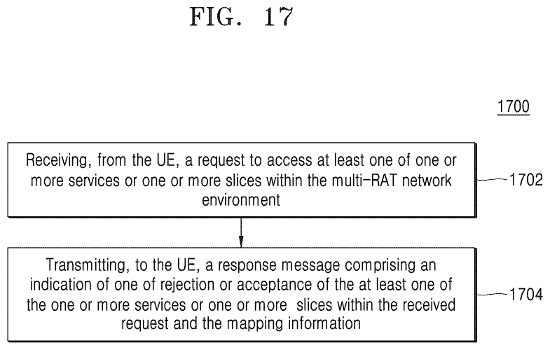

FIG. 17 illustrates a method for enabling access to one or more services to the UE 102 by the network device 104 in the multi-RAT network environment 100.

At operation 1702, the method 1700 may include receiving, from the UE 102, a request to access at least one of one or more services or one or more slices within the multi-RAT network environment 100.

At operation 1704, the method 1700 may include transmitting, to the UE 102, a response message comprising an indication of one of rejection or acceptance of the at least one of the one or more services or one or more slices within the received request and the mapping information. The mapping information may include data such as, but not limited to, a User Equipment Routing Selection Policy (URSP), an Access Network Discovery and Selection Policy (ANDSP), a policy for selecting RAT based on services or slices, a configured Network Slice Selection Assistance Information (NSSAI), an allowed NSSAI, an alternative NSSAI, a slice or service priority, a supported-band related information, a SUPI, and a location associated with each of the one or more RATs within the multi-RAT environment for PLMNs/SNPNs.

In one embodiment, the method 1700 may also include identifying a location of the UE 102. Thereafter, the method 1700 may include determining at least one of one or more RATs associated with the network 104 and/or one or more SUPIs associated with the UE 102 based at least on the received request, the mapping information, a subscription and the location of the UE 102. Next, the method 1700 may include steering the UE 102 to establish connection to at least one of the one or more determined RATs based network or one or more SUPIs of the UE 102.

Embodiments are exemplary in nature and the operations of the method 1700 as shown in FIG. 17 may occur in variations to the sequence in accordance with various embodiments.

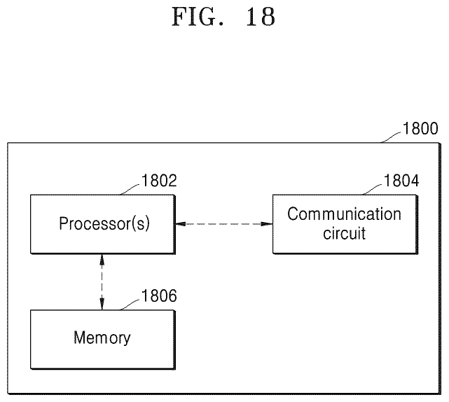

FIG. 18 illustrates a configuration of a UE 1800 in a wireless communication system, according to an embodiment of the disclosure. The configuration of FIG. 18 may be understood as a part of the configuration of the UE 1800. Further, the method 1600 as disclosed above may be implemented in the UE 1800 according to a further embodiment. In an embodiment, the UE 1800 corresponds to the UE 102.

Referring to FIG. 18, the UE 1800 may include at least one processor 1802, a communication circuit 1804 (e.g., communicator or communication interface), and a memory 1806. By way of example, the UE 1800 may be a cellular phone or other device that communicates over a plurality of cellular networks (such as a 3G, 4G, 5G or pre-5G, 6G network or any future wireless communication network). The communication circuit 1904 may perform functions for transmitting and receiving signals via a wireless channel.

As an example, the processor 1802 may be a single processing unit or a number of units, all of which could include multiple computing units. The processor 1802 may be implemented as one or more microprocessors, microcomputers, microcontrollers, digital signal processors, central processing units, state machines, logic circuitries, and/or any devices that manipulate signals based on operational instructions. Among other capabilities, the processor 1802 is configured to fetch and execute computer-readable instructions and data stored in the memory 1806. The processor 1802 may include one or a plurality of processors. At this time, one or a plurality of processors 1802 may be a general-purpose processor, such as a Central Processing Unit (CPU), an Application Processor (AP), or the like, a graphics-only processing unit such as a Graphics Processing Unit (GPU), a Visual Processing Unit (VPU), and/or an AI-dedicated processor such as a Neural Processing Unit (NPU). The one or a plurality of processors 1802 may control the processing of the input data in accordance with a predefined operating rule or Artificial Intelligence (AI) model stored in the non-volatile memory and the volatile memory, i.e., the memory 1806. The predefined operating rule or AI model is provided through training or learning.

The memory 1806 may include any non-transitory computer-readable medium known in the art including, for example, volatile memory, such as Static Random Access Memory (SRAM) and Dynamic Random Access Memory (DRAM), and/or non-volatile memory, such as Read-Only Memory (ROM), erasable programmable ROM, flash memories, hard disks, optical disks, and magnetic tapes.

Embodiments are exemplary in nature, and the UE 1800 may include additional components required to implement the desired functionality of the UE 1800 in accordance with the requirements of the disclosure.

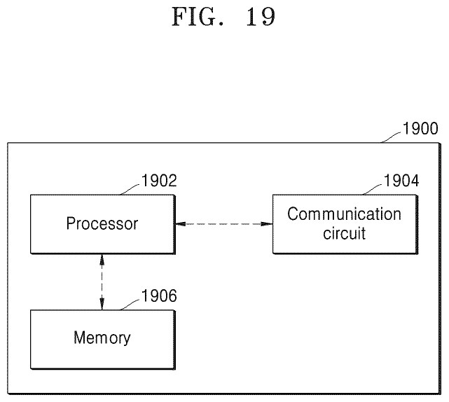

FIG. 19 illustrates an exemplary diagram of a network device 1900 (also referred to as the network 1900), according to an embodiment of the disclosure. The network 1900 may correspond to any suitable network type such as, but not limited to, 5G network, 6G network, and so forth. The network 1900 may include TNs and NTNs. The network 1900 may be configured to perform the method 1700 as discussed above. The network 1900 may correspond to network elements/components as discussed throughout the specification. The network 1900 may include at least one processor 1902, a communication circuit 1904, and a memory 1906. Further, the network 1900 may also include the Cloud-RAN (C-RAN), a Central Unit (CU), a core Network (NW), a Distributed Unit (DU), or the any other possible network (NW) entity. In one embodiment, the network 1900 may correspond to the network 104 and/or associated devices.

The communication circuit 1904 may perform one or more functions for transmitting and receiving signals via a wireless channel. The memory 1906 may be configured to store information/data required by the processor 1902 to perform one or more desired functionalities of the network 1900 in accordance with the disclosure.

The processor 1902, the communication circuit 1904, and the memory 1906 may have similar structure as disclosed in reference to the processor 1802, the communication circuit 1804, and the memory 1806 of the UE 1800, respectively. Accordingly, a detailed description of these components has been omitted for the sake of brevity.

While the embodiments explained above are defined in reference to the term RAT, however the embodiments may be extended and applied to any future technologies and/or communication introduced or used in place of RAT.

Moreover, embodiments illustrated in reference to FIGS. 1-19 are equally application to maritime communication services over 3GPP system.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

What is claimed is:

1. A method for accessing one or more services by a User Equipment (UE) in a multi-Radio Access Technology (multi-RAT) network, the method comprising:
receiving, from one or more applications associated with the UE, a request to access at least one of one or more services or one or more slices within the multi-RAT network;
based on the received request and mapping information, determining at least one of one or more RATs or one or more Subscription Permanent Identifiers (SUPIs), wherein the mapping information indicates a relationship between a plurality of slices and at least one of a plurality of RATs associated with one or more networks within the multi-RAT network and a plurality of SUPIs stored at the UE; and
based on the determined at least one of one or more RATs, and the one or more SUPIs to access the requested at least one of the one or more services or the one or more slices, establishing a connection with at least one of the one or more networks within the multi-RAT network.

2. The method of claim 1, further comprising:
establishing a connection with at least one of the one or more networks within the multi-RAT network;
transmitting the request to the at least one of the one or more networks to access the at least one of the one or more services or one or more the slices; and
receiving a response message indicating one of a rejection or an acceptance of the at least one of the one or more services or one or more the slices and the mapping information.

3. The method of claim 2, further comprising:
based on the received response message indicating the rejection of the at least one of the one or more services or one or more the slices, maintaining a list of networks and associated Tracking Area Identity (TAI) RAT and access environment including at least one of a Standalone Non-Public Network (SNPN), Reduced Capability (REDCAP) network, Terrestrial Network (TN), Non-TN (NTN), Beyond-5G (B5G), or 6G.

4. The method of claim 3, wherein the establishing the connection with at least one of the one or more networks within the multi-RAT network comprises:
identifying a location of the UE; and
based on the received request, the mapping information, the maintained list of networks, and the location of the UE, determining at least one of the one or more RATs or one or more SUPIs

5. The method of claim 4, further comprising:
based on the response message or the mapping information, identifying at least one or more services or slices not supported in a current RAT or a SUPI; and
accessing the one or more identified services or slices by establishing a second connection via the one or more determined RATs or the one or more SUPIs.

6. The method of claim 1, wherein the mapping information comprises at least one of a User Equipment Routing Selection Policy (URSP), an Access Network Discovery and Selection Policy (ANDSP) or a Home Network configured or controlled policy for selecting RAT based on services or slices, a configured Network Slice Selection Assistance Information (NSSAI), an allowed NSSAI, an alternative NSSAI, a slice or service priority, a supported-band related information, a SUPI, and a location associated with each of the one or more RATs within the multi-RAT network for Public Land Mobile Networks PLMNs/Standalone Non-Public Networks (SNPNs).

7. The method of claim 1, wherein the one or more RATs comprises a 5G Non-Terrestrial Network (NTN) or a 5G Terrestrial Network (TN),
wherein priorities of the one or more RATs may be pre-configured in at least one of an Elementary File user controlled PLMN with Access Technology (EFPLMNWACT) file, an Elementary File operator controlled PLMN with Access Technology (EFOPLMNWACT) file, an elementary file home PLMN selector with Access Technology (EFHPLMNWACT) file, or a memory element of the UE, and
wherein the priorities of the one or more RATs are mapped to one or more services or one or more slices in the mapping information.

8. The method of claim 1, wherein the mapping information is pre-configured at the UE.

9. A User Equipment (UE) to access one or more services in a multi-Radio Access Technology (multi-RAT) network, the UE comprising:
at least one processor configured to:
receive, from one or more applications associated with the UE, a request to access at least one of one or more services or one or more slices within the multi-RAT network;
based on received request and mapping information, determine at least one of one or more RATs or one or more Subscription Permanent Identifiers (SUPIs), wherein the mapping information indicates a relationship between a plurality of slices, and at least one of a plurality of RATs associated with one or more networks within the multi-RAT network and a plurality of SUPIs stored at the UE; and
based on the determined at least one of one or more RATs or one or more SUPIs to access the requested at least one of the one or more services or the one or more slices, establish a connection with at least one of the one or more networks within the multi-RAT network.

10. The UE of claim 9, wherein the at least one processor is further configured to:
establish a connection with at least one of the one or more networks within the multi-RAT network;
transmit the request to the at least one of the one or more network to access the at least one of the one or more services or one or more the slices; and
receive a response message indicating one of a rejection or an acceptance of the at least one of the one or more services or one or more the slices and the mapping information.

11. The UE of claim 9, wherein the at least one processor is further configured to:
based on the received response message with the indication of the rejection of the at least one of the one or more services or one or more the slices, maintain a list of networks and associated Tracking Area Identity (TAI) RAT and access environment including a Standalone Non-Public Network (SNPN), Reduced Capability (REDCAP) network, Terrestrial Network (TN), Non-TN (NTN), Beyond-5G (B5G), 6G.

12. The UE of claim 11, wherein the at least one processor is further configured to:
identify a location of the UE; and
based on the received request, the mapping information, the maintained list of networks, and the location of the UE, determine at least one of the one or more RATs or the one or more SUPIs.

13. The UE of claim 12, wherein the at least one processor is further configured to:
identify at least one or more services or slices not supported in a current RAT or a SUPI based on the response message or the mapping information; and
establish a connection via the one or more determined RATs or the one or more services to access the one or more identified services or slices.

14. The UE of claim 9, wherein the mapping information comprises at least one of a User Equipment Routing Selection Policy (URSP), an Access Network Discovery and Selection Policy (ANDSP) or a Home network configured or controlled policy for selecting RAT based on services or slices, a configured Network Slice Selection Assistance Information (NSSAI), an allowed NSSAI, an alternative NSSAI, a slice or service priority, a supported-band related information, a SUPI, and a location associated with each of the one or more RATs within the multi-RAT network for Public Land Mobile Networks PLMNs/Standalone Non-Public Networks (SNPNs).

15. The UE of claim 9, wherein the one or more RATs comprises a 5G Non-Terrestrial Network (NTN) or a 5G Terrestrial Network (TN),
wherein priorities of the one or more RATs may be pre-configured in at least one of an Elementary File user controlled PLMN with Access Technology (EFPLMNWACT) file, an Elementary File operator controlled PLMN with Access Technology (EFOPLMNWACT) file, an elementary file home PLMN selector with Access Technology (EFHPLMNWACT) file, or a memory element of the UE

16. The UE of claim 9, wherein the priorities of the one or more RATs are mapped to one or more services or one or more slices in the mapping information.

17. The UE of claim 9, wherein the mapping information is pre-configured at the UE.

18. A network device for enabling access to one or more services to a User Equipment (UE) in a multi-Radio Access Technology (RAT) network, the network device comprising:
at least one processor configured to:
receive, from the UE, a request to access at least one of one or more services or one or more slices from the network within the multi-RAT network; and
transmit a response message indicating one of a rejection or an acceptance of the at least one of the one or more services or the one or more slices with the received request and mapping information,
wherein the mapping information comprises at least one of a User Equipment Routing Selection Policy (URSP), an Access Network Discovery and Selection Policy (ANDSP), a Home Network configured or controlled policy for selecting RAT based on services or slices, a configured Network Slice Selection Assistance Information (NSSAI), an allowed NSSAI, an alternative NSSAI, a slice or service priority, a supported-band related information, a SUPI, and a location associated with each of the one or more RATs within the multi-RAT network for Public Land Mobile Networks PLMNs/Standalone Non-Public Networks (SNPNs).

19. The network device of claim 18, wherein the at least one processor is further configured to:
identify a location of the UE; and
based at least on the received request, the mapping information, a subscription and the location of the UE, determine at least one of one or more RATs associated with network; and steer the UE to establish a connection to at least one of the one or more determined RATs based network or one or more SUPIs of the UE.

20. The network device of claim 18, wherein the mapping information is pre-configured at the UE.
